(19) United States
(12) Patent Application Publication
(10) Pub. No.: US 2026/0034493 A1
(43) Pub. Date: Feb. 5, 2026

(54) AIR PURIFIER AND METHOD OF CONTROLLING THE SAME

(71) Applicant: SAMSUNG ELECTRONICS CO., LTD., Suwon-si (KR)

(72) Inventors: Hyewon KIM, Suwon-si (KR); Hangeoroo YOU, Suwon-si (KR); Heechan KANG, Suwon-si (KR)

(73) Assignee: SAMSUNG ELECTRONICS CO., LTD., Suwon-si (KR)

(21) Appl. No.: 19/314,318

(22) Filed: Aug. 29, 2025

Related U.S. Application Data
(63) Continuation of application No. PCT/KR2025/011531, filed on Aug. 1, 2025.

(30) Foreign Application Priority Data
Aug. 5, 2024 (KR) 10-2024-0104246

(51) Int. Cl. B01D 46/46; B01D 46/00; B01D 46/42; B01D 46/44; F24F 11/52; F24F 11/65; F24F 11/77; F24F 11/79; F24F 110/64; G06F 9/451

(52) U.S. Cl. CPC B01D 46/46; B01D 46/0047; B01D 46/429; B01D 46/442; F24F 11/52; F24F 11/65; F24F 11/77; F24F 11/79; G06F 9/451; B01D 2273/30; B01D 2279/50; F24F 2110/64

(57) ABSTRACT

An air purifier may include: a dust collection device configured to collect dust from air; a fan configured to generate a flow of air from an indoor space through the dust collection device; a user interface; a communication interface configured to communicate with at least one of a server or a user device; and a processor configured to: identify cleanliness level of the air in the indoor space, control at least one of the user interface to display or the communication interface to transmit to the at least one of the server or the user device, based on a defined interval or a defined number of times, a request for user feedback on the cleanliness level, obtain the user feedback through at least one of the user interface or the communication interface, based on the obtained user feedback, identify a user-perceived cleanliness level of the air in the indoor space, based on the user-perceived cleanliness level, control an operation of the fan, and based on at least one of the obtained user feedback or the cleanliness level, adjust at least one of the defined interval or the defined number of times.

### CROSS-REFERENCES TO RELATED APPLICATIONS

This is a continuation application, under 35 U.S.C. § 111(a), of International Application No. PCT/KR2025/011531, filed Aug. 1, 2025, which claims priority under 35 U.S.C. § 119 to Korean Patent Application No. 10-2024-0104246, filed Aug. 5, 2024, in the Korean Intellectual Property Office, the disclosures of which are incorporated herein in their entireties by reference.

### TECHNICAL FIELD

The present disclosure relates to an air purifier, which provides customized air purification modes in accordance with user-perceived cleanliness, and a method of controlling the same.

### BACKGROUND ART

An air purifier refers to a device used to remove contaminants from air. The air purifier may remove foreign substances, bacteria, viruses, mold, fine dust, chemical materials, which cause offensive odors, and the like that exist in the sucked air.

The air purifier may include intake port for sucking contaminated air and include a blower fan for creating a flow of air.

In the related art, a flow rate of the blower fan is adjusted on the basis of cleanliness, which is based on a dust concentration in an internal space measured by a sensor (hereinafter, referred to as a ‘dust sensor’) installed in the air purifier, or cleanliness in the internal space obtained from a server.

However, there may occur a difference between user-perceived cleanliness and the cleanliness based on the dust concentration measured by the sensor because of various factors (e.g., an installation position of the air purifier or a distance between the air purifier and the user) related to a space (e.g., a living room, a bedroom, or a kitchen) in which the air purifier is installed, and the difference causes a problem of a deterioration in user satisfaction.

### DISCLOSURE

An embodiment of the present disclosure provides an air purifier that calculates user-perceived cleanliness in response to request for user feedback and provides a customized air purification mode in accordance with the user-perceived cleanliness.

An embodiment provides an air purifier may including a dust collection device configured to collect dust from air; a fan configured to generate a flow of air from an indoor space through the dust collection device; a user interface; a communication interface configured to communicate with at least one of a server or a user device; and a processor configured to: identify cleanliness level of the air in the indoor space, control at least one of the user interface to display or the communication interface to transmit to the at least one of the server or the user device, based on a defined interval or a defined number of times, a request for user feedback on the cleanliness level, obtain the user feedback through at least one of the user interface or the communication interface, based on the obtained user feedback, identify a user-perceived cleanliness level of the air in the indoor space, based on the user-perceived cleanliness level, control an operation of the fan, and based on at least one of the obtained user feedback or the cleanliness level, adjust at least one of the defined interval or the defined number of times.

The processor may be further configured to: obtain information about the measured cleanliness from the server through the communication interface, based on the obtained information, identify whether the cleanliness level corresponds to a lowest level, and based on the identifying that the cleanliness level corresponds to the lowest level, determine that an event of extending the defined interval has occurred, wherein the lowest level corresponds to a level indicating the best air quality.

The processor may be further configured to: based on the identifying that the cleanliness level does not correspond to the lowest level, identify whether the cleanliness level changes within a first reference time, and based on the identifying that the identified cleanliness level decreases to at least a defined number of levels within the first reference time, determine that the event of extending the defined interval has occurred, wherein the decrease in the cleanliness level corresponds to an improvement in the air quality.

The processor may be further configured to, based on the determining that the event of extending the defined interval has cumulatively occurred a second defined number of times, extend the defined interval.

The processor may be further configured to: based on the determining that the event of extending the defined interval has cumulatively occurred a second defined number of times, control at least one of the user interface to display or the communication interface to transmit to the at least one of the server or the user device, a request for a user agreement on extending the defined interval, and based on the user agreement on extending the defined interval being obtained, extend the defined interval.

The processor may be further configured to, based on the identifying that the cleanliness level does not decrease to at least the defined number of levels within the first reference time, determine that an event to request for additional user feedback has occurred.

The processor may be further configured to: identify whether the request for user feedback based on the defined interval is scheduled within a second reference time, and based on the identifying that the request for user feedback based on the defined interval is scheduled within the second reference time, withdraw the request for user feedback based on the defined interval.

The request for user feedback includes a question whether an air quality of the air from the indoor space is satisfactory, and the processor may be further configured to, based on the user feedback indicating the air quality of the air from the indoor space is satisfactory being continuously obtained the third defined number of times, determine that an event of extending the defined interval has occurred.

The request for user feedback includes a question whether an air quality of the air from the indoor space is satisfactory, and the processor may be further configured to, based on the user feedback indicating the air quality of the air from the indoor space is unsatisfactory being continuously obtained a fourth defined number of times, determine that an event of shortening the defined interval has occurred.

The processor may be further configured to, based on a determination that the event of extending the defined interval has occurred, extend the defined interval.

The processor may be further configured to, based on a determining that the event of extending the defined interval has occurred, control at least one of the user interface to display or the communication interface to transmit to the at least one of the server or the user device, a question for identifying whether a user agrees to adjust the defined interval, and based on user feedback indicating a user agreement to extend the defined interval being obtained, extend the defined interval.

The request for user feedback includes a question identifying whether an air quality of the air from the indoor space based on cleanliness level is satisfactory, the indoor space includes at least one of an installation space in which the air purifier is installed or a space surrounding the installation space, and the processor may be further configured to, based on the user feedback indicating the air quality of the air from the indoor space is unsatisfactory being obtained, control at least one of the user interface to display or the communication interface to transmit to the at least one of the server or the user device, a question for identifying whether a user is in the installation space.

The processor may be further configured to: based on obtaining the user feedback through at least one of the user interface or the communication interface indicating that the user is in the installation space, identify a difference between the user-perceived cleanliness and the cleanliness level, and based on the identified difference being greater than or equal to a defined difference, determine that an event of adjusting a boundary value of a cleanliness level has occurred.

The processor may be further configured to, based on the determining that the event of adjusting the boundary value of the cleanliness level has cumulatively occurred a fifth defined number of times, adjust a boundary value of a set cleanliness level corresponding to the cleanliness level or control the user interface to output a notification on performance or state of the air purifier.

The processor may be further configured to, based on a determining that the event of adjusting the boundary value of the cleanliness level has cumulatively occurred the fifth defined number of times, decrease an upper limit value and a lower limit value of the boundary value of the set cleanliness level corresponding to the cleanliness level by a defined amount.

The processor may be further configured to, based on a determination that the event of shortening the defined interval has occurred, shorten the defined interval.

The processor may be further configured to, based on a determination that the event of shortening the defined interval as occurred, control at least one of the user interface or the communication interface to display a request for identifying whether a user agreement for an adjustment of the defined interval was made on the user interface or the user device, and based on the identifying the user agreement for the adjustment of the defined interval was made, shorten the defined interval.

The processor may be further configured to, based on a determining that a cumulative number of occurrences of the event of adjusting the boundary value of the cleanliness level is equal to or greater than a threshold number, control at least one of the user interface to display or the communication interface to transmit to the at least one of the server or the user device notification on at least one of a replacement or repair of the dust collection device.

The processor may be further configured to, based on the user-perceived cleanliness, control at least one of a flow rate or a flow direction of the fan.

An embodiment provides a method of controlling an air purifier including identifying cleanliness level of the air in the indoor space, displaying or transmitting, based on a defined interval or a defined number of times, a request for user feedback on the cleanliness level, obtaining the user feedback, based on the obtained user feedback, identifying a user-perceived cleanliness level of the air in the indoor space, based on the user-perceived cleanliness, controlling an operation of the fan, and based on at least one of the obtained user feedback or the cleanliness level, adjusting at least one of the defined interval or the defined number of times.

The air purifier and the method of controlling the same according to the present disclosure may provide the customized user-perceived clean mode on the basis of the user's feedback, thereby improving the functionality of products and the user's satisfaction.

The air purifier and the method of controlling the same according to the present disclosure may determine the user-perceived cleanliness level by adjusting the defined interval of request for user feedbacks or the defined number of request for user feedbacks on the basis of the user feedback, thereby improving the user satisfaction related to the air quality.

Technical problems to be solved by the present document are not limited to the above-mentioned technical problems, and other technical problems, which are not mentioned above, may be clearly understood from the following descriptions by those skilled in the art to which the present disclosure pertains.

### DESCRIPTION OF DRAWINGS

FIG. 1 is a view illustrating a plurality of devices in an IoT environment according to an embodiment.

FIG. 2 is a perspective view of an air purifier according to an embodiment.

FIG. 3 is an enlarged view illustrating portion A in FIG. 2.

FIG. 4 is a cross-sectional view taken along line B-B′ in FIG. 2.

FIG. 5 is a control block diagram of the air purifier according to an embodiment.

FIG. 6 is a view illustrating an example of a cleanliness level classification table in accordance with dust concentration.

FIG. 7 is a control flowchart of the air purifier according to an embodiment.

FIGS. 8 and 9 are views illustrating examples of at least one question included in a request for user feedback and a user response to the question according to an embodiment.

FIGS. 10 to 12 are views illustrating examples of a process in which the air purifier according to an embodiment requests feedback from the user and receives a response to the request.

FIG. 13 is a control flowchart of the air purifier for adjusting dust concentration boundary values in the cleanliness level classification table and outputting a notification for identifying performance according to an embodiment.

FIG. 14 is a view illustrating an example of a control flowchart of the air purifier for adjusting a interval of request for user feedbacks or the number of request for user feedbacks.

FIG. 15 is a view illustrating another example of a control flowchart of the air purifier for adjusting a interval of request for user feedbacks or the number of request for user feedbacks.

FIG. 16 is a view illustrating still another example of a control flowchart of the air purifier for adjusting a interval of the request for user feedbacks or the number of request for user feedbacks.

FIG. 17 is a view illustrating yet another example of a control flowchart of the air purifier for changing a question included in the request for user feedback.

FIGS. 18 to 20 are views illustrating examples of a user interface of an air purifier 20 according to an embodiment.

### MODES OF THE INVENTION

Embodiments disclosed in the present disclosure and the configuration illustrated in the drawings are just preferred examples of the present disclosure. Various modified examples capable of substituting the embodiments and the drawings of the present disclosure may be made at the time of filing the present application.

In addition, like reference numerals or symbols indicated in the respective drawings in the present disclosure refer to members or constituent elements which perform substantially the same functions.

In addition, the terms used in the present disclosure are used only for the purpose of describing particular embodiments and are not intended to restrict and/or limit the present disclosure. Singular expressions include plural expressions unless clearly described as different meanings in the context. In the present disclosure, the terms “including,” “having,” and the like are intended to designate the existence of characteristics, numbers, steps, operations, constituent elements, and components described in the present disclosure or a combination thereof, and do not exclude a possibility of the existence or addition of one or more other characteristics, numbers, steps, operations, constituent elements, and components, or a combination thereof in advance.

In addition, as used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

In addition, the term “and/or” includes any and all constituent elements of a plurality of related and listed constituent elements.

In addition, the terms including ordinal numbers such as “first” and “second” used in the present disclosure may be used to describe various constituent elements, but the constituent elements should not be limited by the terms, and these terms are used only to distinguish one constituent element from another constituent element. For example, a first constituent element may be named a second constituent element, and similarly, the second constituent element may also be named the first constituent element, without departing from the scope of the present disclosure. The term “and/or” includes any and all combinations of a plurality of the related and listed items.

In addition, the term “identical” in the present disclosure means that the attributes are similar or similar within a certain range. In addition, the term “identical” means “substantially identical.” The term “substantially identical” means that numerical values or reference numerical values, which fall within the manufacturing tolerance range, and differences within the range, which are not meaningful, should be understood as falling within the scope of “identical.”

In addition, the term “portion,” “device,” “block,” “member,” “module,” or the like can mean a unit that processes one or more functions or operations. For example, the term may mean at least one process processed by at least one hardware stored in a field-programmable gate array (FPGA), an application specific integrated circuit (ASIC), or the like, or at least one software or processor stored in a memory.

Meanwhile, the terms “front,” “rear,” “left,” “right,” and the like used in the following description are defined based on the drawings, and shapes and positions of the constituent elements are not limited by the terms.

Hereinafter, an air purifier is illustrated as an example. However, the present disclosure is not limited to the air purifier but may be applied to other air conditioners in which air flows. For example, the present disclosure may be applied to cooling and heating devices that are kinds of air conditioners different from the air purifier.

Hereinafter, embodiments according to the present disclosure will be described in detail with reference to the accompanying drawings.

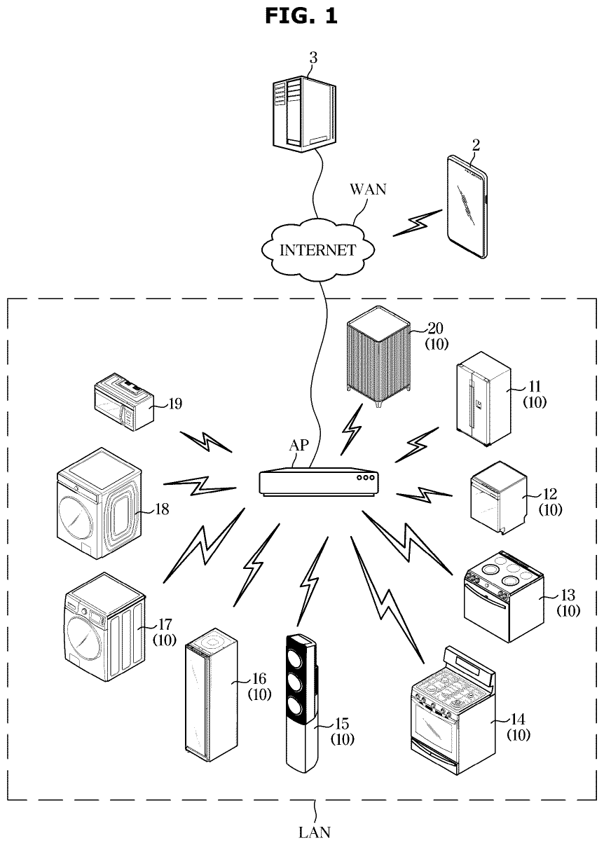

FIG. 1 is a view illustrating a plurality of devices in an IoT environment according to an embodiment.

The IoT environment according to the embodiment may include a user device 2, a server device 3, at least one electronic device 10, and/or a network configured to connect the user device 2, the server device 3, or at least one electronic device 10. In the present disclosure, the user device 2 or at least one electronic device 10 in the IoT environment may be referred to as an IoT device 301.

The electronic device 10 may include a communication module configured to communicate with another household electrical appliance, the user device 2, or the server device 3, a user interface configured to obtain a user input or output information to the user, at least one processor configured to control an operation of the electronic device 10, and at least one memory configured to store a program for controlling the operation of the electronic device 10.

The electronic device 10 may be at least one of various types of household electrical appliances. For example, as illustrated, the electronic devices 10 may include at least one of a refrigerator 11, a dishwasher 12, an electric range 13, an electric oven 14, an air conditioner 15, a clothing care device 16, a washing machine 17, a dryer 18, a microwave oven 19, or the air purifier 20. However, the present disclosure is not limited thereto. For example, the electronic devices 10 may include various types of household electrical appliances such as a cleaning robot, a vacuum cleaner, and a television that are not illustrated in the drawings. In addition, the above-mentioned household electrical appliances are just examples. In addition to the above-mentioned household electrical appliances, the electronic devices 10 according to the embodiment may include devices connected to another household electrical appliance, the user device 2, or the server device 3 and configured to operate the following operations.

The server device 3 may include a communication module configured to communicate with another server, the electronic device 10, or the user device 2, at least one processor configured to process data obtained from another server, the electronic device 10, or the user device 2, and at least one memory configured to store a program for processing data or store the processed data. The server device 3 may be implemented as various computing devices such as a workstation, a cloud, a data drive, or a data station. The server device 3 may be implemented as one or more servers physically or logically distinguished based on functions, detailed configurations of functions, data, or the like and may transmit and obtain data through communication between respective servers and process transmitted and obtained data.

The server device 3 may perform functions such as managing user accounts, registering the electronic device 10 associated with the user account, and managing or controlling the registered electronic device 10. For example, the user may access the server device 3 through the user device 2 and create a user account. The user account may be identified by an ID and password set by the user. The server device 3 may register the electronic device 10 to the user account in accordance with a predetermined procedure. For example, the server device 3 may register, manage, and control the electronic device 10 by linking identification information (e.g., serial number or MAC address, etc.) of the electronic device 10 to the user account. The user device 2 may include a communication module configured to communicate with the electronic device 10 or the server device 3, a user interface configured to obtain a user input or output information to the user, at least one processor configured to control an operation of the user device 2, and at least one memory configured to store a program for controlling the operation of the user device 2.

The user device 2 may be carried by the user or placed in the user's home, office, or the like. The user devices 2 may include a personal computer, a terminal, a portable telephone, a smart phone, a handheld device, a wearable device, and the like. However, the present disclosure is not limited thereto.

The memory of the user device 2 may store a program, i.e., an application, for controlling the electronic device 10. The application is sold in a state installed on the user device 2 or may be downloaded from an external server and installed.

By executing the application installed on the user device 2, the user may access the server device 3 to create the user account and communicate with the server device 3 based on the logged-in user account to register the electronic device 10.

For example, when the electronic device 10 is operated so that the electronic device 10 may access the server device 3 in accordance with the procedure guided by the application installed on the user device 2, the server device 3 registers the identification information of the electronic device 10 (e.g., serial number or MAC address, etc.) in the corresponding user account, thereby registering the electronic device 10 in the user account.

The user may control the electronic device 10 using the application installed on the user device 2. For example, when the user logs into the user account using the application installed on the user device 2, the electronic device 10 registered in the user account appears, and when the user inputs a control instruction for the electronic device 10, the control instruction may be transmitted to the electronic device 10 through the server device 3.

A network may include both wired and wireless networks. The wired networks may include cable networks, telephone networks, and the like whereas wireless networks may include all networks that transmit and obtain signals via radio waves. The wired network and the wireless network may be connected to each other.

The network may include a local area network (LAN) formed around an access point (AP) connected to a wide area network (WAN) such as the Internet, and a short-range wireless network that does not pass through an access point (AP). The short-range wireless networks may include Bluetooth™ (IEEE 802.15.1), Zigbee (IEEE 802.15.4), Wi-Fi Direct, NFC (Near Field Communication), Z-Wave, etc. However, the present disclosure is not limited thereto.

The access point (AP) may connect the electronic device 10 or the user device 2 to the wide area network (WAN) to which the server device 3 is connected. The electronic device 10 or the user device 2 may be connected to the server device 3 via the wide area network (WAN).

The access point (AP) may communicate with the electronic device 10 or the user device 2 using wireless communication such as Wi-Fi™ (IEEE 802.11), Bluetooth™ (IEEE 802.15.1), and Zigbee (IEEE 802.15.4) and other wireless communications, and may access the wide area network (WAN) using wired communications. However, the present disclosure is not limited thereto.

According to various embodiments, the electronic device 10 may be directly connected to the user device 2 or the server device 3 without passing through the access point (AP).

The electronic device 10 may be connected to the user device 2 or the server device 3 via a long-range wireless network or a short-range wireless network.

For example, the electronic device 10 may be connected to the user device 2 via a short-range wireless network (e.g., Wi-Fi Direct).

In still another example, the electronic device 10 may be connected to the user device 2 or the server device 3 via the wide area network (WAN) using the long-range wireless network (e.g., cellular communication module).

In yet another example, the electronic device 10 may access the wide area network (WAN) using the wired communication and may be connected to the user device 2 or the server device 3 through the wide area network (WAN).

In case the electronic device 10 may access the wide area network (WAN) by using wired communication, the electronic device 10 may also operate as the access point. Therefore, the electronic device 10 may connect another household electrical appliance to the wide area network (WAN) to which the server device 3 is connected. In addition, another household electrical appliance may connect the electronic device 10 to the wide area network (WAN) to which the server device 3 is connected.

The electronic device 10 may transfer information about an operation or status to another household electrical appliance, the user device 2, or the server device 3 through the network. For example, in case that a request is obtained from the server device 3 or a particular event occurs in the electronic device 10, the electronic device 10 may transfer, periodically or in real time, information about the operation or status to another household electrical appliance, the user device 2, or the server device 3.

When the information about the operation or status is obtained from the electronic device 10, the server device 3 may update the stored information about the operation or status of the electronic device 10 and transfer the updated information about the operation and status of the electronic device 10 to the user device 2 through the network. Here, updating information may include various operations that change existing information, such as adding new information to existing information or replacing existing information with new information.

The electronic device 10 may acquire various types of information from another household electrical appliance, the user device 2, or the server device 3 and provide the acquired information to the user. For example, the electronic device 10 may obtain information related to the functions of the electronic device 10 (e.g., recipes, washing methods, etc.) and various environmental information (e.g., weather, temperature, humidity, etc.) from the server device 3, and output the obtained information through the user interface.

The electronic device 10 may operate in response to the control instruction obtained from another household electrical appliance, the user device 2, or the server device 3. For example, in case that the electronic device 10 has obtained prior approval from the user so that the electronic device 10 may operate in response to the control instruction from the server device 3 even without a user input, the electronic device 10 may operate in response to the control instruction obtained from the server device 3. In this case, the control instructions obtained from the server device 3 may include control instructions inputted by the user through the user device 2, control instructions based on defined conditions, or the like. However, the present disclosure is not limited thereto.

The user device 2 may transfer information about the user to the electronic device 10 or the server device 3 through a communication module. For example, the user device 2 may transfer information about the user's location, the user's health condition, the user's preferences, the user's schedule, and the like to the server device 3. The user device 2 may transfer information about the user to the server device 3 based on the user's prior approval.

The electronic device 10, the user device 2, or the server device 3 may determine control instructions using technologies such as artificial intelligence. For example, the server device 3 may obtain information about the operation or status of the electronic device 10 or information about the user of the user device 2, process the information using technologies such as artificial intelligence, and transmit the processing results or control instructions to the electronic device 10 or the user device 2 on the basis of the processing results.

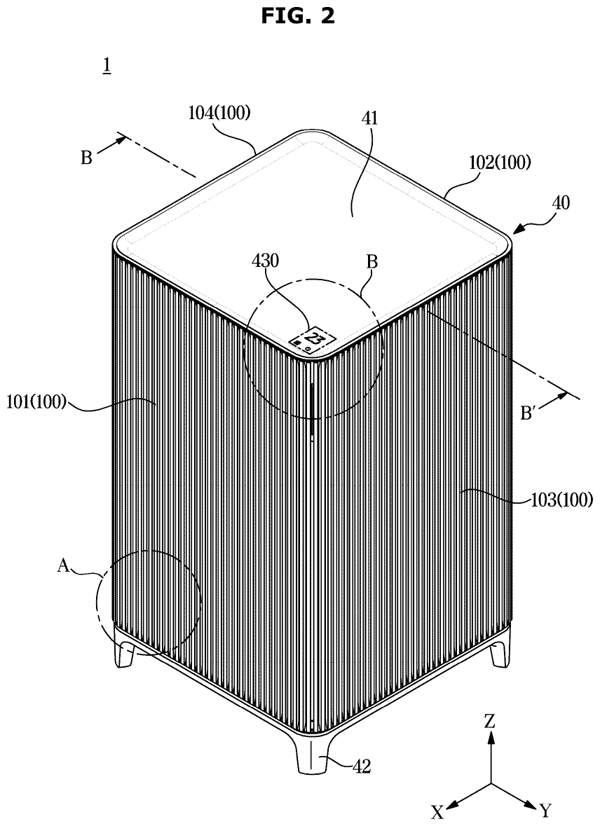

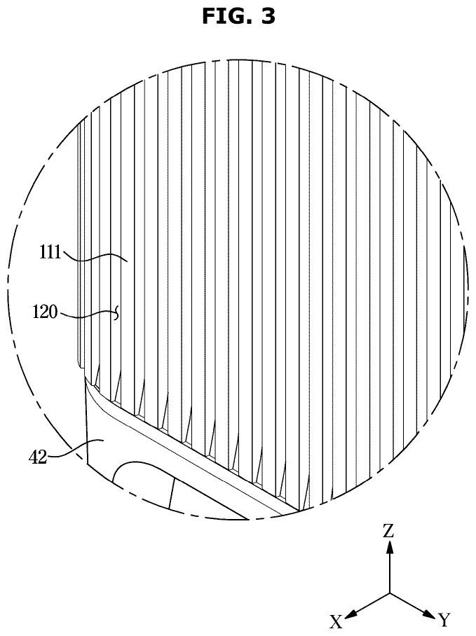

FIG. 2 is a perspective view of the air purifier 20 according to an embodiment, and FIG. 3 is an enlarged view illustrating portion A in FIG. 1.

With reference to FIGS. 2 and 3, the air purifier 20 may include a housing 40. The housing 40 may define an external appearance of the air purifier 20.

The housing 40 may include a blowing panel 100 and an upper panel 41. The upper panel 41 may be provided at an upper end of the housing 40. The upper panel 41 may be disposed above the blowing panel 100.

A user interface 430 may be provided on the upper panel 41. The user interface 430 may be implemented as a display panel. The user interface 430 may obtain the user's input or output operational information of the air purifier 20 to the user.

The blowing panel 100 may include a first panel 101, a second panel 102, a third panel 103, and a fourth panel 104. The first panel 101 may define a front side of the housing 40, the second panel 102 may define a rear side of the housing 40, and the third panel 103 and the fourth panel 104 may define sides of the housing 40. The third panel 103 and the fourth panel 104 may connect the first panel 101 and the second panel 102. The first panel 101 may be a front panel, the second panel 102 may be a rear panel, the third panel 103 may be a left panel, and the fourth panel 104 may be a right panel. The first panel 101, the second panel 102, the third panel 103, and the fourth panel 104 may be integrated.

The blowing panel 100 may include a panel portion 110 and a blowing port 120.

The panel portion 110 may include a plurality of panel ribs 111. The plurality of panel ribs 111 may extend in one direction. For example, the plurality of panel ribs 111 may extend in an upward/downward direction. However, the present disclosure is not limited thereto. The panel portion 110 may be formed over the entire region of the blowing panel 100.

The blowing port 120 may be formed to correspond to the panel portion 110. For example, the blowing port 120 may have openings formed between the plurality of panel ribs 111 of the panel portion 110. Outside air existing outside the housing 40 may be sucked into the housing 40 through the blowing port 120, or the air may be discharged from the housing 40. The blowing port 120 may include a plurality of openings.

The air purifier 20 may include the blowing port 120. For example, the blowing panel 100 may have the blowing port 120 so that outside air is introduced into or discharged from the air purifier 20. The blowing port 120 may extend in the upward/downward direction. The blowing port 120 may be provided as a plurality of blowing ports 120. The plurality of blowing ports 120 may be arranged in a direction perpendicular to the upward/downward direction. For example, the plurality of blowing ports 120 may be arranged in a leftward/rightward direction or a forward/rearward direction.

The air blown by a blower fan 30 may pass through the blowing ports 120. The blowing ports 120 may include a panel intake port 121 and a discharge port 122. The panel intake port 121 may be formed at an upstream side of the discharge port 122. However, the positions of the panel intake port 121 and the discharge port 122 are not limited thereto.

The panel intake port 121 and the discharge port 122 may be formed in each of the first panel 101, the second panel 102, the third panel 103, and the fourth panel 104. For example, the panel intake ports 121 and the discharge ports 122 may be formed in a front surface, a rear surface, a left surface, and a right surface of the housing 40.

For example, outside air existing outside the housing 40 may be introduced into the housing 40 through the panel intake ports 121 in all directions. The outside air existing outside the housing 40 may be introduced into the housing 40 through the panel intake ports 121 in all directions. In addition, the air in the housing 40 may flow to the outside of the housing 40 through the discharge ports 122 in all directions.

The air purifier 20 according to the embodiment may include a dust collection device 80 accommodated in the housing 40 and configured to collect foreign substances contained in the air sucked by the blower fan 30. The dust collection device 80 may include a dust collection filter configured to remove dust mixed with the air introduced from the outside.

According to various embodiments, the dust collection device 80 may be implemented as an electric dust collection device including an electrification portion and a dust collection portion. The electrification portion may electrify aerosol in the air. The dust collection portion may capture aerosol electrified by the electrification portion and remove the aerosol from the air. The electrification portion may be disposed at an upstream side of the dust collection portion.

Because the air purifier 20 according to the embodiment sucks the air in all directions, the air smoothly circulates in the housing 40, thereby achieving high dust collection efficiency together with the dust collection device 80.

The housing 40 may include a support 42. The support 42 may be disposed below the housing 40 and support the elements that constitute the housing 40 and the air purifier 20. The support 42 may be provided as a plurality of supports 42 to stably support the components of the air purifier 20. Specifically, the supports 42 may be provided between the first panel 101 and the fourth panel 104, between the fourth panel 104 and the second panel 102, between the second panel 102 and the third panel 103, and between the third panel 103 and the first panel 101. However, this is just an example. The support 42 only needs to be formed to stably support the air purifier 20.

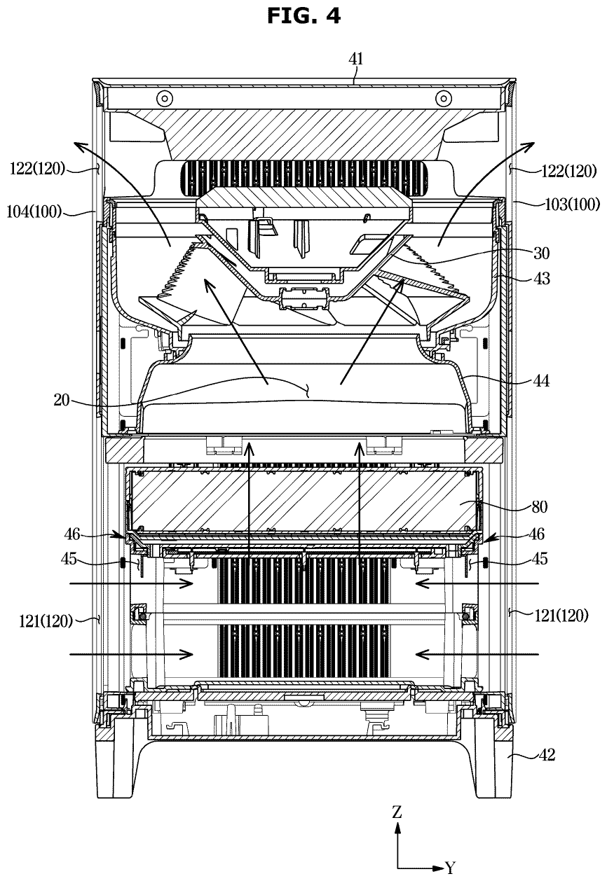

FIG. 4 is a cross-sectional view taken along line B-B′ in FIG. 1. Specifically, FIG. 4 is a view illustrating the components and a flow of air in the air purifier 20.

With reference to FIG. 4, the air introduced into the housing 40 from the outside may pass through the housing 40 in an air flow direction and be discharged to the outside of the housing 40. The air flow direction may be a direction directed from an upstream side toward a downstream side of an air flow path 20. The air flow direction may be a direction in which the air is introduced into the housing 40 through the panel intake port 121 and a housing intake port 45, passes through the dust collection device 80 and the blower fan 30, and then flows toward the discharge port 122. For example, the air flow direction may be a direction in which the air is introduced into the housing 40 through the panel intake port 121 and the housing intake port 45, changes in direction by a predetermined angle, and then passes through the dust collection device 80 and the blower fan 30. For example, the air sucked into front, rear, left, and right sides of the housing 40 by the blower fan 30 may flow upward and then be discharged through the front, rear, left, and right sides of the housing 40. However, the flow direction of the air is not limited to the above-mentioned example.

The housing 40 may include an air guide 44. The air flowing into the housing 40 through the intake port may be guided toward the blower fan 30 through the air guide 44. The air guide 44 may define a portion of the flow path 20 therein. The air guide 44 may guide the air in the housing 40 and/or the flow path 20 toward the blower fan 30. The air passing through the air guide 44 may flow into a fan housing 43 and the blower fan 30.

The blower fan 30 may be disposed in the fan housing 43. The fan housing 43 may define a portion of the flow path 20 therein. The fan housing 43 may guide a flow of the air flowing in the housing 40. The fan housing 43 may communicate with the air guide 44.

The flow path 20 may be formed in the housing 40. The blower fan 30 may be disposed in the flow path 20. The flow path 20 may include the panel intake port 121, the housing intake port 45, and the discharge port 122. The air blown by the blower fan 30 may flow along the flow path 20. For example, the air having passed through the panel intake port 121 may flow to the housing intake port 45, and the air introduced into the flow path 20 through the housing intake port 45 may pass through the dust collection device 80 and then flow to the discharge port 122. The air having flowed through the discharge port 122 may be discharged to the outside of the flow path 20.

The outside air existing outside the housing 40 may be introduced into the housing 40 through the housing intake port 45 in all directions. For example, the outside air existing outside the housing 40 may be introduced into the housing 40 through the housing intake port 45 in all directions. In addition, for example, the air in the housing 40 may flow to the outside of the housing 40 through the discharge ports 122 in all directions.

The embodiment has been described in which the panel intake port 121 and the housing intake port 45 are separately formed. However, the panel intake port 121 and the housing intake port 45 may be configured as a single constituent element.

The air purifier 20 may include the dust collection device 80. The dust collection device 80 may be disposed in the housing 40. For example, the dust collection device 80 may be fixed in the housing 40 by a casing 46. The dust collection device 80 may filter the air by capturing dust in the air.

The air purifier 20 may include various dust collection filters in addition to the dust collection device 80. For example, fine dust collection filters in the form of non-woven fabrics made of polypropylene resin or polyethylene resin and/or granular activated carbon filters may be selectively provided.

The blowing panel 100 may be disposed at an upstream side of the dust collection device 80 based on the air flow direction and prevent the dust collection device 80 from being exposed to the outside of the housing 40. The panel portion 110 of the blowing panel 100 may cover the dust collection device 80. The panel portion 110 may be disposed at the upstream side of the dust collection device 80 based on the air flow direction.

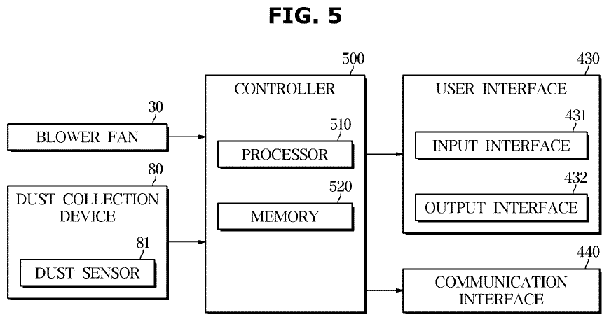

FIG. 5 is a control block diagram of the air purifier 20 according to an embodiment.

With reference to FIG. 5, the air purifier 20 may include the blower fan 30, the dust collection device 80, the user interface 430, a communication interface 440, and/or a controller 500. In addition, according to various embodiments, the air purifier 20 may further include a temperature sensor and/or a humidity sensor. The controller 500 may be electrically connected to constituent elements of the air purifier 20 and control each of the constituent elements. The constituent elements of the air purifier 20 are not limited to those exemplarily described. Some of the above-mentioned constituent elements of the air purifier 20 may be excluded, or another constituent element may be added.

The blower fan 30 may include a motor and a blade. In the present disclosure, a configuration in which the blower fan 30 is controlled by a processor 510 may include a configuration in which the motor configured to apply a rotational force to the blower fan 30 is controlled by the processor 510. The outside air existing outside the air purifier 20 may be introduced into the air purifier 20 by an operation of the blower fan 30. In addition, the air introduced into the air purifier 20 may pass through the dust collection device 80 and then be discharged to the outside of the air purifier 20.

The dust collection device 80 may be mounted in the air purifier 20 and remove dust contained in the air introduced through the intake port 121. In addition, the dust collection device 80 may be implemented as an electric dust collection device. The dust collection device 80 may create an electric field, and the created electric field may apply electrical attractive forces to dust particles in the air and attract the dust particles. In case that the dust collection device 80 is implemented as the electric dust collection device, the controller 500 may control a power supplier (not illustrated) to supply power to the dust collection device 80.

The dust collection device 80 may further include a dust sensor 81 configured to detect dust concentration of the air passing through the dust collection filter. The dust sensor 81 may generate a detection signal corresponding to the detection of the dust concentration and transmit the detection signal to the controller 500. That is, the dust sensor 81 may transfer information about dust concentration in a current indoor space for calculating cleanliness of the air filtered while passing through the dust collection filter to the controller 500. In this case, the term ‘indoor space’ may include means a space in which the air purifier 20 is installed, and the indoor space may include an interior of a room, an interior of a house, or the like. The controller 500 may identify measured cleanliness based on a sensor measurement value on the basis of the dust concentration in the indoor space obtained from the dust sensor 81. An operation of the dust sensor 81 may be initiated on the basis that the air purifier 20 is turned on.

The user interface 430 may include an input interface 431 and an output interface 432.

The input interface 431 may include various buttons, dials, and/or touch displays. The input interface 431 may acquire various user inputs related to the operation or request of the air purifier 20. The input interface 431 may output an electrical signal (voltage or electric current) corresponding to the user input to the controller 500 of the air purifier 20. For example, a flow rate in an air purification mode may be selected by means of the user interface 430. For example, the controller 500 may perform an air purification operation on the basis of the selected flow rate. In addition, the user interface 430 may obtain a response to the request for user feedback related to the cleanliness in the indoor space.

In addition, the input interface 431 may include a microphone configured to acquire a user voice input. Therefore, the user interface 430 may obtain a voice signal related to the response to the request for user feedback related to the cleanliness in the indoor space.

The output interface 432 may display information about the status and/or operation of the air purifier 20. The output interface 432 may display, on various screens, information inputted by the user through the input interface 431 or information provided to the user. The output interface 432 may output at least one question included in the request for user feedback related to the cleanliness in the indoor space as auditory or visual information.

The output interface 432 may include various types of display panels. For example, the output interface 432 may include a liquid crystal display panel (LCD panel), a light-emitting diode panel (LED panel), an organic light-emitting diode panel (OLED panel), or a micro-LED panel. The output interface 432 may be implemented as a touch display. The touch display may include a display panel configured to display an image, and a touch panel configured to obtain a touch input. The display panel may convert image data obtained by the controller 500 into optical signals that may be visually recognized by the user. The touch panel may identify the user's touch input and provide the controller 500 with an electrical signal corresponding to the obtained touch input. In case that the output interface 432 is provided as the touch display, the input interface 431 may not be provided.

Therefore, the output interface 432 may display information about the status and/or operation of the air purifier 20 by means of a graphic user interface (GUI) that enables control of the air purifier 20. That is, the output interface 432 may display a user interface element (UI element) such as an icon.

The output interface 432 may further include a speaker configured to output a sound. Therefore, the user interface 430 may output at least one question in the form of auditory information included in the request for user feedback related to the cleanliness in the indoor space.

The communication interface 440 may perform communication connection with at least one of the user device 2 or the server device 3 through the network. The controller 500 may transmit or obtain various types of information, various signals, and/or various data to or from the external device (e.g., user device or server) through the communication interface 440. For example, the communication interface 440 may transmit or obtain a control signal for requesting user feedback related to the indoor air measured cleanliness to or from the server. The controller 500 may acquire firmware and/or software for the air purifier 20 from the server through the communication interface 440.

The communication interface 440 may include various communication circuits. The communication interface 440 may include a wireless communication circuit and/or a wired communication circuit. For example, communication circuits supporting wireless communication methods such as wireless local area network (wireless LAN), home radio frequency (Home RF), infrared communication, ultra-wide band (UWB) communication, Wi-Fi, Bluetooth, and Zigbee may be provided.

The controller 500 may include the processor 510 and a memory 520. The processor 510 may generate a control signal for controlling the operation of the air purifier 20 on the basis of the instruction, application, data, and/or program stored in the memory 520. The processor 510 may include a logic circuit and a computation circuit as hardware. The processor 510 may process data in accordance with the program and/or instruction provided from the memory 520 and generate the control signal in response to the processing result. The processor 510 and the memory 520 may be implemented as a single control circuit or a plurality of circuits.

The memory 520 may memorize/store various types of information required to operate the air purifier 20. The memory 520 may store the instruction, application, data, and/or program required to operate the air purifier 20. The memory 520 may include volatile memory such as a static random access memory (S-RAM) or a dynamic random access memory (D-RAM) for temporarily storing data. In addition, the memory 520 may include non-volatile memory such as a read only memory (ROM), an erasable programmable read only memory (EPROM), or an electrically erasable programmable read only memory (EEPROM) for storing data for a long period of time.

The processor 510 may be electrically connected to the blower fan 30, the dust collection device 80, the user interface 430, and/or the communication interface 440 and control the operations of the blower fan 30, the dust collection device 80, the user interface 430, and/or the communication interface 440.

According to the embodiment, the processor 510 may control at least one of the user interface 430 or the communication interface 440 so that the request for user feedback related to the measured cleanliness in the indoor space (hereinafter, referred to as ‘measured cleanliness’) is displayed on the user interface 430 or the user device 2 in accordance with a defined interval or a defined number of times. In this case, the request for user feedback related to the measured cleanliness may include at least one question.

In addition, the processor 510 may obtain the user response to the feedback request through at least one of the user interface 430 or the communication interface 440. In this case, the user response may include at least one response to at least one question included in the request for user feedback related to the measured cleanliness in the indoor space.

The processor 510 may identify user-perceived cleanliness corresponding to the measured cleanliness on the basis of the user response and control the operation of the blower fan 30 on the basis of the user-perceived cleanliness.

The operation of controlling the operation of the blower fan 30 may include a configuration for adjusting at least one of a flow rate or a flow direction of the blower fan 30 on the basis of the identified user-perceived cleanliness. In addition, the operation of controlling the operation of the blower fan 30 may include an operation of controlling the blower fan 30 so that the blower fan 30 operates with a defined flow rate or flow direction in accordance with an operating mode of the air purifier 20 initiated on the basis of the identified user-perceived cleanliness. In addition, the operation of controlling the operation of the blower fan 30 may include an operation of controlling the blower fan 30 so that the blower fan 30 operates with a determined flow rate or flow direction in accordance with a defined method in an operating mode of the air purifier 20 initiated on the basis of the identified user-perceived cleanliness. The operation of controlling the blower fan 30 may include an operation of controlling the motor configured to apply the rotational force to the blower fan 30.

The processor 510 may adjust at least one of the defined interval of request for user feedbacks or the number of request for user feedbacks on the basis of at least one of the user response or the measured cleanliness. In this case, the operation of adjusting the interval of request for user feedbacks may include an operation of extending or shortening the interval of request for user feedbacks.

According to the embodiment of the present disclosure, the processor 510 may process a series of control operations of the processor 510 or acquire additional information by using an artificial intelligence (AI) model. The artificial intelligence model may be stored in the memory 520 and provided on the air purifier 20 or the external device. In this case, the external device may include the server device 3 or the user device 2. The processor 510 may use a plurality of artificial intelligence (AI) models. The processor 510 may use the plurality of artificial intelligence models to process separate control operations or acquire separate additional information.

For example, the processor 510 may identify the user-perceived cleanliness by using the artificial intelligence model and control various types of components (e.g., the blower fan 30) of the air purifier 20 on the basis of the identified user-perceived cleanliness. In still another example, the processor 510 may obtain the user-perceived cleanliness, which is acquired by the artificial intelligence model stored in the external device, through the communication interface 440 and control various types of components of the air purifier 20, e.g., the blower fan 30 on the basis of the obtained user-perceived cleanliness. The external device (e.g., the server device 3) configured to store the artificial intelligence model may acquire various types of information for determining the user-perceived cleanliness from another external device or the air purifier 20 and determine the user-perceived cleanliness by using the artificial intelligence model on the basis of the acquired information.

The artificial intelligence model may be implemented by using various artificial neural network models or deep neural network models. In addition, the artificial intelligence model may be learned and generated using various machine learning algorithms or deep learning algorithms. Artificial intelligence models may be implemented using models such as a convolutional neural network (CNN), a recurrent neural network (RNN), a generative adversarial network (GAN), and a long-short-term memory (LSTM).

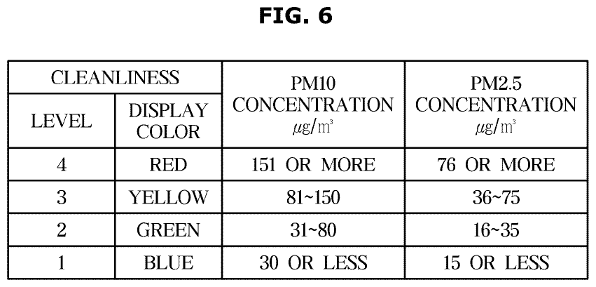

FIG. 6 is a view illustrating an example of a cleanliness level classification table in accordance with dust concentration.

According to an embodiment, the memory 520 may store data related to the cleanliness level classification table in accordance with the dust concentration. The cleanliness level classification table is a table that assigns predetermined levels in accordance with a dust concentration range on the basis of defined criteria. The dust concentration of the air decreases as the level decreases, and the dust concentration of the air increases as the level increases. In other words, the cleanliness level may indicate a degree of air quality. That is, the air quality may be improved as the level decreases, and the air quality may be degraded as the level increases. Therefore, when the level is high or increases, it is necessary to increase the flow rate of the blower fan 30 to improve the air quality by filtering out dust from the air. In this case, the dust concentration ranges corresponding to the respective levels may be updated from the server device 3 or adjusted when it is determined that a defined event occurs.

In the present disclosure, the ‘measured cleanliness (SensorPM)’ in the indoor space may refer to the dust concentration in the indoor space measured by the sensor, and the cleanliness level may correspond to a level determined in accordance with the cleanliness level classification table on the basis of the measured cleanliness.

For example, the processor 510 may identify the cleanliness level in the indoor space by comparing information about the measured cleanliness, which is acquired by the dust sensor 81 provided in the dust collection device 80, with the level classification table stored in the memory 520.

In yet another example, the processor 510 may obtain information about integrated measured cleanliness in the indoor space identified on the basis of the measured cleanliness in the indoor space measured by at least one of the other electronic devices 10 (specifically, a sensor of another electronic device 10) in the IoT environment from the server device 3 through the communication interface 440. Therefore, the processor 510 may also identify the cleanliness level in the indoor space by comparing the information about the integrated measured cleanliness acquired from the server device 3 with the level classification table stored in the memory 520.

That is, the processor 510 may identify the cleanliness level on the basis of the measured cleanliness in the indoor space acquired from the dust sensor 81 or the server device 3. For example, in case that the measured cleanliness in the indoor space obtained from the server device 3 is PM10=60 (μg/m³), the cleanliness level in the indoor space may be determined as Level 2.

The cleanliness level classification table according to the dust concentration stored in the memory 520 may include information about defined colors displayed on the user interface 430 or the user device 2 in accordance with the level in order to provide the user with information about the current cleanliness in the indoor space (or air quality). For example, in case that the measured cleanliness in the indoor space obtained from the server device 3 is PM10=60 (μg/m³), the processor 510 may provide the user with information about the current cleanliness in the indoor space (or air quality) by displaying a green color in various shapes on the user interface 430 or the user device 2.

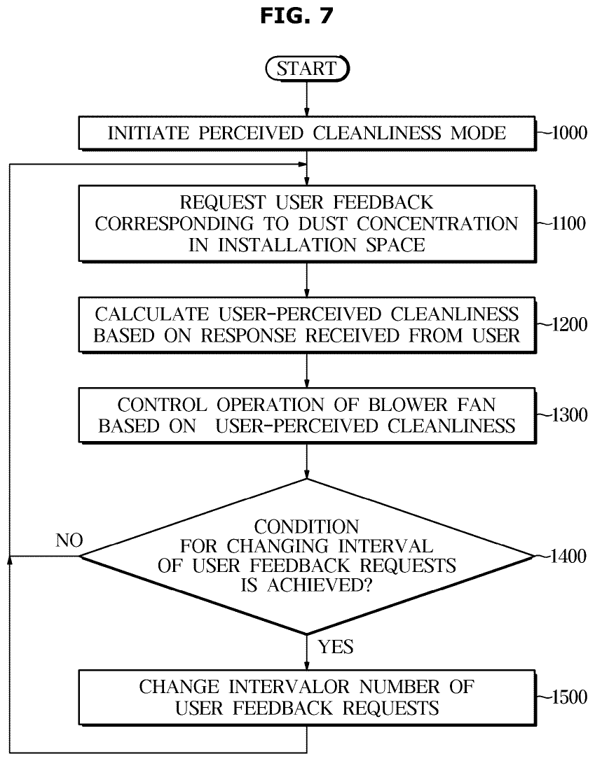

Hereinafter, a control flowchart of the air purifier 20 for performing the air purification operation in a user customized manner by determining user customized perceived cleanliness on the basis of the user's feedback and adjusting at least one of the defined interval of request for user feedbacks or the number of request for user feedbacks will be described with reference to FIG. 7.

FIG. 7 is a control flowchart of the air purifier according to an embodiment.

According to the embodiment, the processor 510 may initiate the perceived cleanliness mode on the basis that a user input related to a perceived cleanliness mode initiation is obtained from the user interface 430 or a defined condition is satisfied (1000). For example, the processor 510 may initiate the perceived cleanliness mode on the basis that an input related to the adjustment of the flow rate of the blower fan 30 is obtained from the user interface 430 defined number of times within a defined period of time (e.g., five or more times for an hour).

The processor 510 may request the user for the user feedback related to the measured cleanliness in the indoor space (1100). In this case, the operation of requesting for the user feedback related to the measured cleanliness in the indoor space may include an operation of controlling at least one of the user interface 430 or the communication interface 440 so that the request for user feedback related to the measured cleanliness in the indoor space is displayed on at least one of the user interface 430 or the user device 2.

In this case, the request for user feedback related to the measured cleanliness in the indoor space may be displayed as various types of sensory information. For example, the processor 510 may display the request for user feedback as visual information by controlling the output interface 432 including a display device. In still another example, the processor 510 may transmit a data packet related to the request for user feedback to the server device 3 to display the request for user feedback in the form of a pop-up message on the user device 2 by controlling the communication interface 440. In yet another example, the processor 510 may transmit the data packet related to the request for user feedback to the server device 3 to display the request for user feedback in the form of a pop-up message on the user device 2 by controlling the communication interface 440 while displaying the request for user feedback as auditory information by controlling the output interface 432 including the speaker.

In addition, the operation of displaying the request for user feedback related to the measured cleanliness in the indoor space on the user interface 430 or the user device 2 may include an operation of displaying at least one question included in the request for user feedback on the user interface 430 or the user device 2.

The processor 510 may obtain the user response to the feedback request and identify the user-perceived cleanliness on the basis of the response obtained from the user (1200).

The processor 510 may obtain the user response as sensory information through an input interface 531. In addition, the processor 510 may obtain the user response, which is obtained by the user device 2, from the server device 3.

The operation of obtaining the user response to the feedback request may include an operation of obtaining at least one response of the user to at least one question included in the request for user feedback.

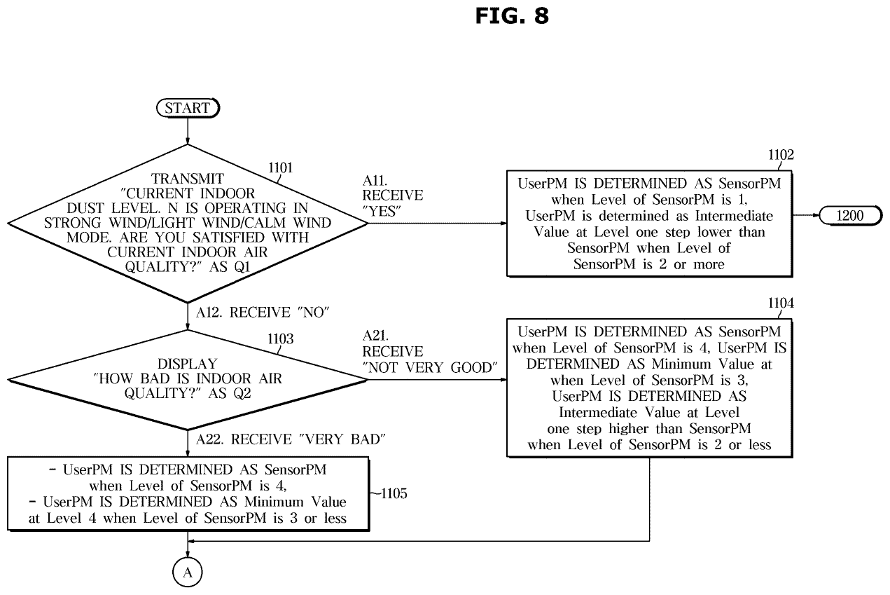

The processor 510 may determine ‘user response-applied measured cleanliness (UserPM)’ on the basis of the obtained user response. The ‘user response-applied measured cleanliness’ may be determined on the basis of a user response related to measured cleanliness and current air quality satisfaction. A method of determining the ‘user response-applied measured cleanliness’ will be described below in detail with reference to FIG. 8.

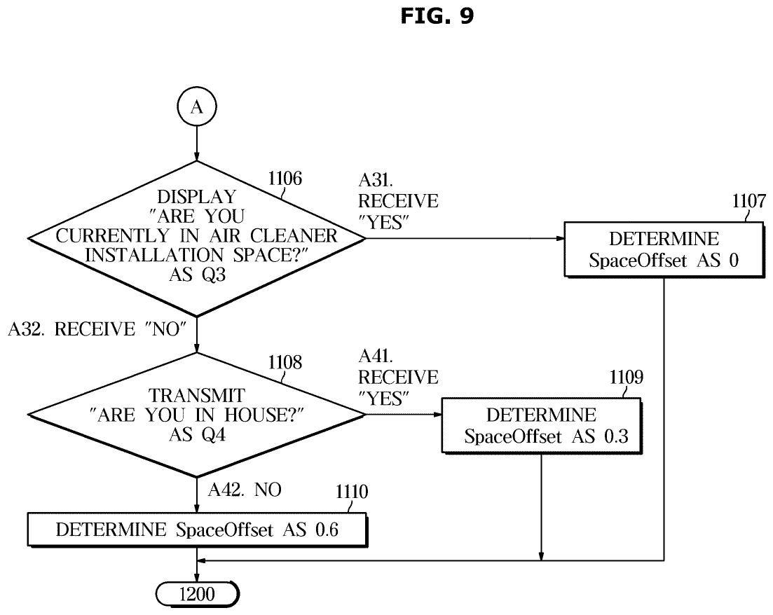

The processor 510 may determine ‘user space reliability (SpaceOffset)’ on the basis of the obtained user response. The ‘user space reliability’ refers to a factor for correcting reliability related to the user response related to the current air quality satisfaction and may be determined on the basis of whether the user is present in the indoor space and a distance from the air purifier 20. A method of determining the ‘user space reliability’ will be described below in detail with reference to FIG. 9.

The processor 510 may identify ‘user-perceived cleanliness (AdvancedPM)’ on the basis of at least one of the user response-applied measured cleanliness or the user space reliability in case that at least one of the user response-applied measured cleanliness or the user space reliability is determined. The user-perceived cleanliness may be determined by applying the user feedback to the measured cleanliness and may be the cleanliness that is actually recognized by the user.

According to the embodiment, the method of calculating the user-perceived cleanliness may be based on Equation 1 below.

User-Perceived Cleanliness(AdvancedPM)=UserPM*(0.6−SpaceOffset)+SensorPM*(0.3+SpaceOffset)+OutPM*0.1 [Equation 1]

In this case, atmospheric cleanliness (OutPM) refers to atmospheric dust concentration and is determined in consideration of a deterioration in air quality caused by the introduction of air (i.e., outside air) into the indoor space.

On days when the air quality is very poor (e.g., yellow dust, high ultra-fine dust concentration), the amount of (ultra) fine dust introduced from the outside is larger than on clear days, so it is necessary to operate the air purifier 20 at a higher flow rate than usual. Therefore, the value is made by applying this situation. The processor 510 may acquire information about the atmospheric cleanliness (OutPM) from the server device 3 through the communication interface 440.

However, the constant values in the above equation are not fixed and may be varied as long as a sum thereof does not exceed 1.

The processor 510 may identify the user-perceived cleanliness by using the artificial intelligence model stored in the memory 520.

Specifically, the artificial intelligence model stored in the memory 520 may include a first artificial intelligence model including SensorPM, OutPM, or the user response as the input data and the user-perceived cleanliness as the output data. The first artificial intelligence model may perform learning based on input and output data. In this case, the activation function that processes and converts the input data between the input data and the output data may include Equation 1.

Therefore, the processor 510 may identify the user-perceived cleanliness by inputting SensorPM, OutPM, or the user response to the learned first artificial intelligence model.

The processor 510 may control the operation of the blower fan 30 on the basis of the identified user-perceived cleanliness (1300).

In this case, the operation of controlling the operation of the blower fan 30 may include the configuration for adjusting at least one of the flow rate or the flow direction of the blower fan 30 on the basis of the identified user-perceived cleanliness. In addition, the operation of controlling the operation of the blower fan 30 may include the operation of controlling the blower fan 30 so that the blower fan 30 operates with the defined flow rate or flow direction in accordance with the operating mode of the air purifier 20 initiated on the basis of the identified user-perceived cleanliness. In addition, the operation of controlling the operation of the blower fan 30 may include the operation of controlling the blower fan 30 so that the blower fan 30 operates with the determined flow rate or flow direction in accordance with the defined method in the operating mode of the air purifier 20 initiated on the basis of the identified user-perceived cleanliness. The operation of controlling the blower fan 30 may include the operation of controlling the motor configured to apply the rotational force to the blower fan 30.

For example, the processor 510 may adjust the flow rate of the blower fan 30 by using the artificial intelligence model stored in the memory 520.

Specifically, the artificial intelligence model stored in the memory 520 may include a second artificial intelligence model including SensorPM, OutPM, or the identified user-perceived cleanliness as the input data and the flow rate of the blower fan 30 as the output. The second artificial intelligence model may perform learning based on input and output data determined in accordance with the input data. Therefore, the processor 510 may calculate flow rate information of the blower fan 30 by inputting SensorPM, OutPM, or the user-perceived cleanliness to the learned second artificial intelligence model.

In this case, the first artificial intelligence model and the second artificial intelligence model may be implemented as a single artificial intelligence model. In case that the first artificial intelligence model and the second artificial intelligence model are implemented as the single artificial intelligence model, the learning may be performed by using SensorPM, OutPM, or the user response as the input data and the flow rate of the blower fan 30 as the output data. That is, the user-perceived cleanliness is a value identified within the model, which may be a value processed and converted in a hidden layer.

According to various embodiments, the first artificial intelligence model or the second artificial intelligence model may be provided on the external device (e.g., the server device 3 or the user device 2).

The processor 510 may receive, through the communication interface 440, the information about the user-perceived cleanliness acquired by using the second artificial intelligence model in the external device, and the processor 510 may adjust the flow rate of the blower fan 30 on the basis of the user-perceived cleanliness obtained from the external device. In this case, the operation of acquiring the user-perceived cleanliness in the external device may be performed by a method of calculating the user-perceived cleanliness by the first artificial intelligence model stored in the memory 520 of the air purifier 20.

In addition, the processor 510 may obtain a control instruction for adjusting the flow rate of the blower fan 30 created by using the second artificial intelligence model in the external device and adjust the flow rate of the blower fan 30 on the basis of the control instruction. In this case, the operation of creating the control instruction for adjusting the flow rate of the blower fan 30 in the external device may be performed by a method of calculating information about the flow rate of the blower fan 30 by the second artificial intelligence model stored in the memory 520 of the air purifier 20. The processor 510 may determine whether the condition for adjusting the interval of request for user feedbacks or the number of request for user feedbacks is satisfied (1400).

The configuration in which the condition for adjusting the interval of request for user feedbacks or the number of request for user feedbacks is satisfied may include the occurrence of the event of extending an interval of the request for user feedbacks, the occurrence of the event of shortening an interval of the request for user feedbacks, or the occurrence of event of making an additional request for user feedback.

In addition, the configuration in which the condition for adjusting the interval of request for user feedbacks or the number of request for user feedbacks is satisfied may include a configuration in which the event of extending an interval of the request for user feedbacks, the event of shortening an interval of the request for user feedbacks, or event of making an additional request for user feedback continuously occur defined number of times.

In addition, the configuration in which the condition for adjusting the interval of request for user feedbacks or the number of request for user feedbacks is satisfied may include a configuration in which the reception of a user agreement on the adjustment of the interval of request for user feedbacks or the number of request for user feedbacks is simultaneously satisfied together with at least one of the occurrence of the event of extending an interval of the request for user feedbacks, the occurrence of the event of shortening an interval of the request for user feedbacks, or the occurrence of event of making an additional request for user feedback.

In case that the processor 510 determines that the condition for adjusting the interval of request for user feedbacks or the number of request for user feedbacks is not satisfied (NO in 1400), the processor 510 may request the user feedback in accordance with the defined interval of request for user feedbacks or the number of request for user feedbacks. For example, the processor 510 may control at least one of the user interface 430 or the communication interface 440 to request feedback from the user six times a day, twice each at two-hour intervals in the morning, afternoon, and evening (i.e., at eight o'clock, ten o'clock, twelve o'clock, fourteen o'clock, sixteen o'clock, and eighteen o'clock).

In contrast, in case that the processor 510 determines that the condition for adjusting the interval of request for user feedbacks or the number of request for user feedbacks is satisfied (YES in 1400), the processor 510 may adjust the interval of request for user feedbacks or the number of request for user feedbacks and request the user feedback in accordance with the adjusted cycle or the adjusted number of times (1500).

In this case, the processor 510 may adjust the interval of request for user feedbacks or the number of request for user feedbacks by using the artificial intelligence model.

Specifically, the artificial intelligence model may include a third artificial intelligence model including SensorPM or the user response to the current and past request for user feedbacks as the input data and the interval of request for user feedbacks or the number of request for user feedbacks as the output data. The third artificial intelligence model may perform learning based on input and output data. Therefore, the processor 510 may calculate information about the interval of request for user feedbacks or the number of request for user feedbacks by inputting SensorPM or the user response to the current and past request for user feedbacks to the learned third artificial intelligence model.

According to various embodiments, the third artificial intelligence model may be provided on the external device (e.g., the server device 3 or the user device 2).

The processor 510 may receive, through the communication interface 440, the information about the interval of request for user feedbacks or the number of request for user feedbacks acquired by using the third artificial intelligence model in external device, and the processor 510 may adjust the interval of request for user feedbacks or the number of request for user feedbacks on the basis of the information about the interval of request for user feedbacks or the number of request for user feedbacks obtained from external device. In this case, the operation of acquiring the information about the interval of request for user feedbacks or the number of request for user feedbacks in the external device may be performed by the method of calculating the information about the interval of request for user feedbacks or the number of request for user feedbacks by the third artificial intelligence model stored in the memory 520 of the air purifier 20. FIGS. 8 and 9 are views illustrating examples of at least one question included in a request for user feedback and a user response to the question according to an embodiment.

Hereinafter, the measured cleanliness is referred to as SensorPM, the user response-applied measured cleanliness is referred to as UserPM, and the user space reliability is referred to as SpaceOffset.

FIG. 8 is a view illustrating an example of at least one question included in the request for user feedback for determining the ‘user response-applied measured cleanliness (UserPM)’ and a user response to the question.

According to the embodiment, the processor 510 may control at least one of the user interface 430 or the communication interface 440 to display a question related to whether the user is satisfied with the air quality according to the current measured cleanliness as a first question Q1 on at least one of the user interface 430 or the user device 2 (1101). In this case, the processor 510 may display the information about the current measured cleanliness and/or air quality together with the first question.

For example, the first question “Current indoor dust level. N is operating in strong wind/light wind/calm wind mode. Are you satisfied with current indoor air quality?” may be displayed on at least one of the user interface 430 or the user device 2.

The processor 510 may determine whether one of first responses defined to correspond to the first question is obtained, and the processor 510 may determine the user response-applied measured cleanliness in response to the obtained first response.

Specifically, in case that the processor 510 receives a response (e.g., “YES” A11) as the first response indicating that the user is satisfied, the processor 510 may determine UserPM=SensorPM in case that the level of SensorPM is 1 in the cleanliness level classification table, and the processor 510 may determine UserPM as an intermediate value at a level one step lower than SensorPM in case that the level of SensorPM is 2 or more (1102).

In case that the processor 510 receives a response (e.g., “NO” A12) as the first response indicating that the user is not satisfied, the processor 510 may control at least one of the user interface 430 or the communication interface 440 to display a question related to a degree of dissatisfaction on the air quality according to the current measured cleanliness as a second question Q2 on at least one of the user interface 430 or the user device 2 (1103).

For example, the second question “How bad is indoor air quality?” may be displayed on at least one of the user interface 430 or the user device 2.

The processor 510 may determine whether one of second responses defined to correspond to the second question is obtained, and the processor 510 may determine the user response-applied measured cleanliness in response to the obtained second response.

Specifically, in case that the processor 510 receives a response (e.g., “Not very good” A21), which indicates that a degree of the user's dissatisfaction is low, as the second response, the processor 510 may determine UserPM=SensorPM in case that the level of SensorPM in the cleanliness level classification table is 4, the processor 510 may determine UserPM=Level of 4, i.e., a minimum value in case that the level of SensorPM is 3, and the processor 510 may determine UserPM is an intermediate value at a level one step higher than SensorPM in case that the level of SensorPM is 2 or less (1104).

Specifically, in case that the processor 510 receives a response (e.g., “Very bad” A22), which indicates that the degree of the user's dissatisfaction is high, as the second response, the processor 510 may determine UserPM=SensorPM in case that the level of SensorPM in the cleanliness level classification table is 4, and the processor 510 may determine UserPM=Level of 4, i.e., a minimum value in case that the level of SensorPM is 3 or less (1105).

According to the embodiment, on the basis that the response of dissatisfaction to the first question related to whether the user is satisfied with the current air quality is obtained, the processor 510 may control at least one of the user interface 430 or the communication interface 440 to display a question related to a positional relationship between the user and the air purifier 20 in order to determine the user space reliability for correcting the reliability of the user's response.

FIG. 9 is a view illustrating an example of at least one question included in the request for user feedback for determining the ‘user space reliability (SpaceOffset)’ and a user response to the question.

According to the embodiment, the processor 510 may control at least one of the user interface 430 or the communication interface 440 to display a question related to whether the current user is present in an installation space of the air purifier 20 as a third question Q3 on at least one of the user interface 430 or the user device 2 (1101). For example, the installation space may correspond to a room (1106).

For example, the third question “Are you currently in air purifier installation space?” may be displayed on at least one of the user interface 430 or the user device 2.

The processor 510 may determine whether one of third responses defined to correspond to the third question is obtained, and the processor 510 may determine the user space reliability in response to the obtained third response.

Specifically, in case that the processor 510 receives a response (e.g., “YES” A31) as the third response indicating that the user is present in the installation space of the air purifier 20, the processor 510 may determine SpaceOffset as 0 (1107).

In case that the processor 510 receives a response (e.g., “NO” A32) as the first response indicating that the user is not present in the installation space of the air purifier 20, the processor 510 may control at least one of the user interface 430 or the communication interface 440 to display a question related to whether the current user is present in the indoor space including the installation space of the air purifier 20 as a fourth question Q4 on at least one of the user interface 430 or the user device 2 (1108). For example, the indoor space may be a house including a room.

For example, the fourth question “Are you in house?” may be disposed on at least one of the user interface 430 or the user device 2.

The processor 510 may determine whether one of fourth responses defined to correspond to the fourth question is obtained, and the processor 510 may determine the user space reliability in response to the obtained fourth response.

Specifically, in case that the processor 510 receives a response (e.g., “YES” A41) as the fourth response indicating that the user is present in the indoor space, the processor 510 may determine SpaceOffset as 0.3 (1108).

Specifically, in case that the processor 510 receives a response (e.g., “NO” A42) as the fourth response indicating that the user is not present in the indoor space, the processor 510 may determine SpaceOffset as 0.6 (1109).

According to the embodiment, the processor 510 may determine at least one of the user response-applied measured cleanliness or the user space reliability and identify the user-perceived cleanliness on the basis of at least one of the determined user response-applied measured cleanliness or the determined user space reliability (1200).

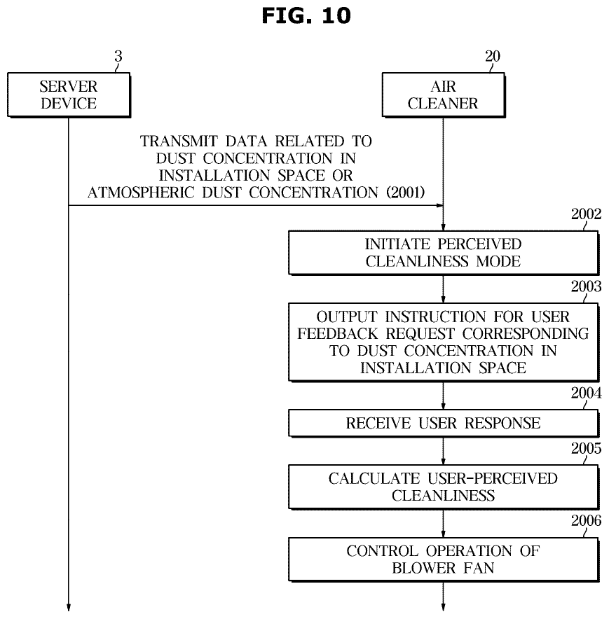

FIGS. 10 to 12 are views illustrating examples of a process in which the air purifier according to an embodiment requests feedback from the user and receives a response to the request.

The processor 510 may request feedback including at least one question (e.g., first to fourth questions in FIGS. 8 and 9) included in the request for user feedback directly and indirectly from the user and obtain at least one response (e.g., first to fourth responses in FIGS. 8 and 9) related to at least one question (e.g., first to fourth questions in FIGS. 8 and 9) included in the request for user feedback directly and indirectly from the user.

FIG. 10 is a view illustrating an example of a process of requesting the user feedback directly from the user and directly obtaining the user response.

According to the embodiment, the air purifier 20 may obtain data related to the indoor space measured cleanliness or atmospheric cleanliness transmitted by the server device 3 (2001). In this case, the transmission and reception of data may be performed between the server device 3 and the communication interface 440 of the air purifier 20.

The air purifier 20 may initiate the perceived cleanliness mode on the basis that the user input related to the perceived cleanliness mode initiation is obtained or the defined condition is satisfied (2002). Therefore, the air purifier 20 may display the request for user feedback corresponding to the indoor space measured cleanliness on the output interface 432 (2003). The operation of displaying the request for user feedback on the output interface 432 may include an operation of displaying at least one question included in the request for user feedback on the output interface 432. In this case, at least one question may be displayed in the form of visual or auditory information on the output interface 432.

The air purifier 20 may obtain the user response to the request for user feedback (2004). In this case, the operation of obtaining the user response to the request for user feedback may include an operation of obtaining at least one response to at least one question included in the request for user feedback. The user response to the request for user feedback may be obtained in the form of sensory information by the input interface 431. For example, the user may touch a button implemented as a graphic user interface (GUI) on the input interface 431 including the touch display, and the user response may be obtained in the form of tactile information through the user touch.

The air purifier 20 may identify the user-perceived cleanliness on the basis of the obtained user response (2005). Therefore, the air purifier 20 may control the operation of the blower fan 30 on the basis of the perceived cleanliness (2006).

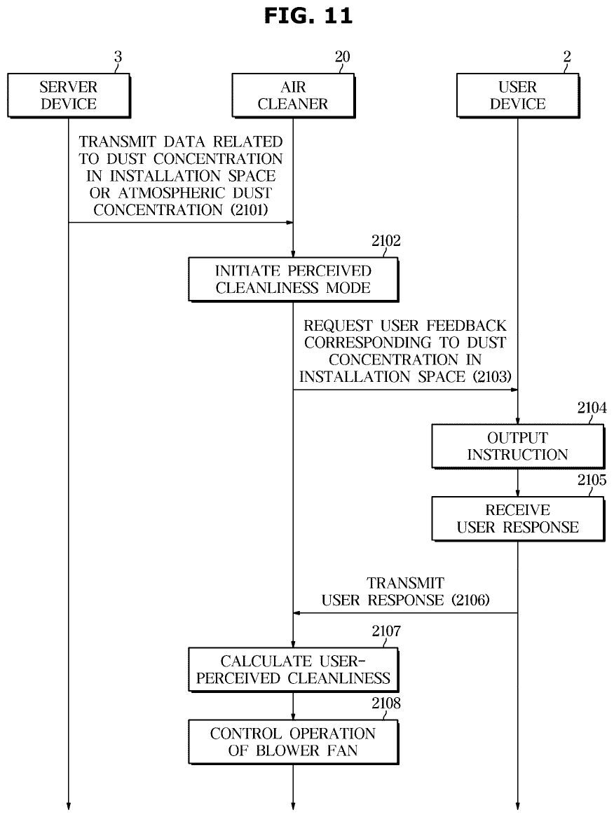

FIG. 11 is a view illustrating an example of a process of indirectly requesting the user feedback through the server device 3 and indirectly obtaining the user response.

According to the embodiment, the air purifier 20 may obtain data related to the indoor space measured cleanliness or atmospheric cleanliness transmitted by the server device 3 (2101). In this case, the transmission and reception of data may be performed between the server device 3 and the communication interface 440 of the air purifier 20. The air purifier 20 may initiate the perceived cleanliness mode on the basis that the user input related to the perceived cleanliness mode initiation is obtained or the defined condition is satisfied (2102).

In case that the perceived cleanliness mode is initiated, the air purifier 20 may transmit the request for user feedback corresponding to the indoor space measured cleanliness to the user device 2 by performing communication with the user device 2 through the communication interface 440 (2103). The operation of transmitting the request for user feedback corresponding to the indoor space measured cleanliness to the user device 2 may include an operation of transmitting, by the air purifier 20, the data packet related to at least one question included in the request for user feedback to the user device 2 and transmitting the control instruction to display the request for user feedback on the user device 2. In this case, in case that the air purifier 20 and the user device 2 are directly connected through Bluetooth or the like, the request for user feedback may be transmitted directly to the user device 2 from the air purifier 20. In case that the air purifier 20 and the user device 2 are connected via the access point, the request for user feedback may be transmitted to the user device 2 via the access point.

Therefore, the user device 2 may output at least one question included in the request for user feedback on the basis of the obtained data packet or control instruction (2104).

Thereafter, the user device 2 may obtain the user response to the request for user feedback (2105) and transmits the obtained user response to the air purifier 20 through the connected communication (2106). The operation of transmitting the user response to the air purifier 20 may include an operation of transmitting, by the air purifier 20, the data packet coupled to the response to at least one question included in the request for user feedback transmitted to the user device 2. In this case, in case that the air purifier 20 and the user device 2 are directly connected through Bluetooth or the like, the user response may be transmitted directly to the user device 2 from the air purifier 20. In case that the air purifier 20 and the user device 2 are connected via the access point, the user response may be transmitted to the air purifier 20 via the access point.

The air purifier 20 may identify the user-perceived cleanliness on the basis of the obtained user response (2107). Therefore, the air purifier 20 may control the operation of the blower fan 30 on the basis of the perceived cleanliness (2108).

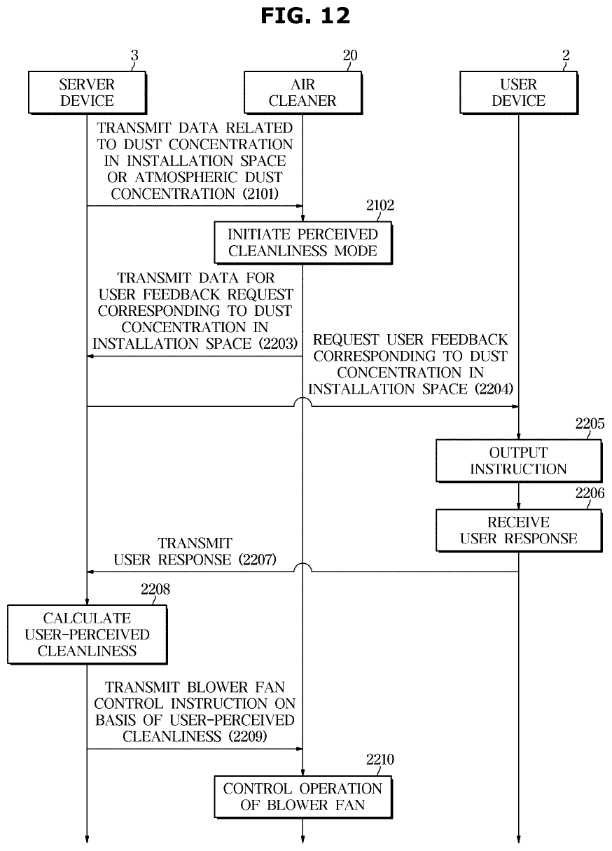

FIG. 12 is a view illustrating an example in which the user feedback is indirectly requested through the server device 3, the user response is indirectly obtained, and information about the identified perceived cleanliness is obtained from the server device 3.

According to the embodiment, the air purifier 20 may obtain data related to the indoor space measured cleanliness or atmospheric cleanliness transmitted by the server device 3 (2201). In this case, the transmission and reception of data may be performed between the server device 3 and the communication interface 440 of the air purifier 20. The air purifier 20 may initiate the perceived cleanliness mode on the basis that the user input related to the perceived cleanliness mode initiation is obtained or the defined condition is satisfied (2202).

In case that the perceived cleanliness mode is initiated, the air purifier 20 may transmit the data for the request for user feedback corresponding to the indoor space measured cleanliness to the server device 3 by performing communication with the server device 3 through the communication interface 440 (2203). The operation of transmitting the data for the request for user feedback corresponding to the indoor space measured cleanliness to the server device 3 may include an operation of transmitting, by the air purifier 20, the data packet related to at least one question included in the request for user feedback to the server device 3, transmitting the control instruction to display the request for user feedback on the server device 3, and/or transmitting the control signal for targeting the server device 3.

The server device 3, which receives the data for the request for user feedback corresponding to the indoor space measured cleanliness from the air purifier 20, may transmit the request for user feedback corresponding to the indoor space measured cleanliness to the targeted user device 2 (2204). The operation of transmitting the request for user feedback corresponding to the indoor space measured cleanliness to the user device 2 may include the operation of transmitting, by the air purifier 20, the data packet related to at least one question included in the request for user feedback to the user device 2 and transmitting the control instruction to display the request for user feedback on the user device 2.

Therefore, the user device 2 may output at least one question included in the request for user feedback on the basis of the obtained data packet or control instruction (2205).

Thereafter, the user device 2 may obtain the user response to the request for user feedback (2206) and transmits the obtained user response to the server device 3 to which the user device 2 is connected (2207).

Therefore, the server device 3 may identify the user-perceived cleanliness on the basis of the obtained user response (2208). In this case, a series of operations of calculating the user-perceived cleanliness by the server device 3 may include a series of operations of calculating the user-perceived cleanliness by the processor 510 of the air purifier 20.

The server device 3 may transmit the data related to the identified user-perceived cleanliness or the control instruction for the blower fan 30 based on the data to the air purifier 20 (2209). Therefore, the air purifier 20 may control the operation of the blower fan 30 on the basis of the data related to the user-perceived cleanliness acquired from the server device 3 or the control instruction for the blower fan 30 based on the data (2210).

The method of transmitting and obtaining various data/control instructions between the air purifier 20, the server device 3, and the user device 2 has been described above. However, the method is just an example. Any method may be adopted as the method of obtaining the request for user feedback and the response to the request for user feedback as long as the method may transmit and obtain the data between the air purifier 20, the server device 3, and the user device 2.

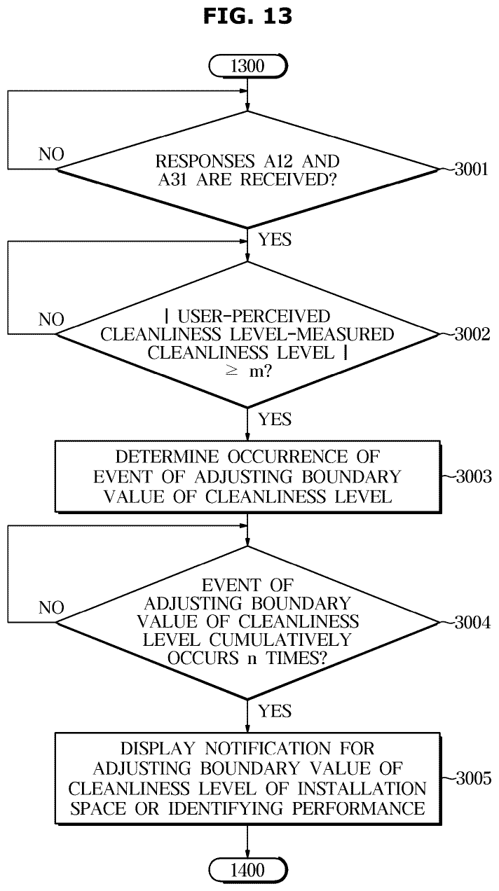

FIG. 13 is a control flowchart of the air purifier 20 for adjusting dust concentration boundary values in the cleanliness level classification table and outputting a notification for identifying performance according to an embodiment.

According to the embodiment, the processor 510 may determine whether a event of adjusting a boundary value of a cleanliness level occurs on the basis of the obtained user response, the user-perceived cleanliness according to the user response, and/or the measured cleanliness. Thereafter, the processor 510 may adjust a dust concentration boundary value of each of the levels in the cleanliness level classification table set in advance on the basis of whether a cleanliness level boundary value adjustment condition or a notification output condition for identifying performance occurs and stored in the memory 520, or the processor 510 may control the output interface 432 to output a notification for identifying performance of the air purifier 20.

With reference to FIG. 13, the processor 510 may control the user interface or the communication interface to display a question for identifying whether the user is positioned in the installation space on the basis of the reception of the user response A12, which indicates dissatisfaction, to the question for identifying whether the air quality according to the measured cleanliness is satisfied on the user interface or the user device. Therefore, the processor 510 may determine whether the user response (hereinafter, referred to as ‘A12’), which indicates dissatisfaction, to the question for identifying whether the air quality according to the measured cleanliness is satisfied and whether the response (e.g., referred to as ‘A31’), which indicates that the user is positioned in the current installation space, to the question for identifying whether the user is positioned in the installation space are obtained (3001).

The processor 510 may determine whether a level difference between the identified user-perceived cleanliness level and the cleanliness level is equal to or more than a defined level difference m on the basis that responses A12 and A31 are obtained (YES in 3001) (3002). The defined level differences m for which the processor 510 adjusts the dust concentration boundary value of each of the levels in the cleanliness level classification table or controlling the output interface 432 to output the notification for identifying the performance of the air purifier 20 may be identical or different.

In case that the determined level difference is determined as being equal to or more than a defined level difference (YES in 3002), the processor 510 may determine that the event of adjusting the boundary value of the cleanliness level occurs.

The processor 510 may determine whether the event of adjusting the boundary value of the cleanliness level cumulatively occurs a defined number of times (n times) (i.e., a fifth defined number of times) while repeating the request for user feedback and response reception in accordance with a defined interval, a changed interval, or the number of times (3004).

In case that the processor 510 determines that the event of adjusting the boundary value of the cleanliness level cumulatively occurs a defined number of times (n times) (i.e., a fifth defined number of times) (YES in 3004), the processor 510 may control the user interface 430 to adjust the boundary value of the level to which the measured cleanliness is determined as belonging and output the notification for identifying the performance of the air purifier (3005).

Specifically, on the basis that the event of adjusting the boundary value of the cleanliness level cumulatively occurs a defined number of times (i.e., a fifth defined number of times), the processor 510 may decrease, by a defined amount of decrease, an upper limit value and a lower limit value of the boundary value of the level to which the cleanliness level is determined as belonging.

That is, in case that the event of adjusting the boundary value of the cleanliness level cumulatively occurs three times, the processor 510 may decrease the boundary value of the level, to which the cleanliness level is determined as belonging, by 6 μg/m³ in the case of PM10 or by 3 μg/m³ in the case of PM2.5. In case that the event of adjusting the boundary value of the cleanliness level cumulatively occurs six times, the processor 510 may decrease the boundary value of the level, to which the cleanliness level is determined as belonging, by 12 μg/m³ in the case of PM10 or by 6 μg/m³ in the case of PM2.5.

For example, in case that the measured cleanliness is 23 μg/m³ (PM2.5), the level, to which the cleanliness level is determined as belonging, may be determined as Level 2 with respect to the cleanliness level classification table in FIG. 6. In this case, in case that event of adjusting the boundary value of the cleanliness level cumulatively occurs three times, an upper limit value of a PM2.5 concentration range corresponding to Level 2 may be adjusted to 32 μg/m³ by being decreased by 3 μg/m³, and the lower limit value may be adjusted to 13 μg/m³ by being decreased by 3 μg/m³. In addition, in case that the event of adjusting the boundary value of the cleanliness level cumulatively occurs six times, an upper limit value of a PM2.5 concentration range corresponding to Level 2 may be adjusted to 29 μg/m³ by being decreased by 6 μg/m³, and the lower limit value may be adjusted to 10 μg/m³ by being decreased by 3 μg/m³.

That is, as the event of adjusting the boundary value of the cleanliness level cumulatively occurs a defined unit number of times, the boundary value of the level, to which the cleanliness level is determined as belonging, may be adjusted by a defined unit amount of decrease.

In another example, on the basis that the event of adjusting the boundary value of the cleanliness level cumulatively occurs a defined number of times (i.e., a fifth defined number of times), the processor 510 may increase the amount of decrease of the upper limit value and the lower limit value of the boundary value of the level, to which the cleanliness level is determined as belonging, as the number of times the event of adjusting the boundary value of the cleanliness level cumulatively occurs is increased.

That is, in case that the event of adjusting the boundary value of the cleanliness level cumulatively occurs three times, the processor 510 may decrease the boundary value of the level, to which the cleanliness level is determined as belonging, by 6 μg/m³ in the case of PM10 or by 3 μg/m³ in the case of PM2.5. In case that the event of adjusting the boundary value of the cleanliness level cumulatively occurs six times (i.e., the number of times the event of adjusting the boundary value of the cleanliness level cumulatively occurs is increased), the processor 510 may decrease the boundary value of the level, to which the cleanliness level is determined as belonging, by 15 μg/m³ in the case of PM10 or by 8 μg/m³ in the case of PM2.5.

For example, in case that the measured cleanliness is 23 μg/m³ (PM2.5), the level, to which the cleanliness level is determined as belonging, may be determined as Level 2 with respect to the cleanliness level classification table in FIG. 6. In this case, in case that the event of adjusting the boundary value of the cleanliness level cumulatively occurs three times, an upper limit value of a PM2.5 concentration range corresponding to Level 2 may be adjusted to 32 μg/m³ by being decreased by 3 μg/m³, and the lower limit value may be adjusted to 13 μg/m³ by being decreased by 3 μg/m³. In addition, in case that the event of adjusting the boundary value of the cleanliness level cumulatively occurs six times, an upper limit value of a PM2.5 concentration range corresponding to Level 2 may be adjusted to 27 μg/m⁸ by being decreased by 8 μg/m³, and the lower limit value may be adjusted to 8 μg/m³ by being decreased by 8 μg/m³.

According to various embodiments, the processor 510 may increase or decrease the cleanliness level boundary value so that the cleanliness level boundary value, which is adjusted on the basis of the occurrence of the event of initiating the cleanliness level boundary value, has a defined initial value.

For example, the processor 510 may determine whether the event of initiating the cleanliness level boundary value occurs on the basis of the user input obtained from the input interface 431 or the communication interface 440.

The air purifier 20 may obtain the user input related to the initialization instruction of the air purifier 20 or the user input related to the cleanliness level boundary value initialization from the input interface 431. In addition, the air purifier 20 may obtain the user input related to the initialization instruction of the air purifier 20 or the user input related to the cleanliness level boundary value initialization obtained by the external device through the communication interface 440.

The processor 510 may determine that the cleanliness level boundary value initialization event occurs on the basis that the processor 510 receives the user input related to the initialization instruction of the air purifier 20 or the user input related to the cleanliness level boundary value initialization from the input interface 431 or the communication interface 440.

In still another example, the processor 510 may determine whether the event of initiating the cleanliness level boundary value occurs on the basis of whether the adjustment of the cleanliness level boundary value is performed for a defined period of time.

The configuration in which the adjustment of the cleanliness level boundary value is not performed for a defined period of time may include a configuration in which the flow rate of the blower fan 30 is adjusted in response to the continuous feedback request, the cleanliness in the indoor space is improved by adjusting the cleanliness level boundary value, and a gap between the user-perceived cleanliness and the measured cleanliness is reduced. Therefore, the processor 510 may determine that the event of initiating the cleanliness level boundary value occurs on the basis that the adjustment of the cleanliness level boundary value is not performed for a defined period of time.

Therefore, the processor 510 may increase or decrease the boundary value of the level, to which the cleanliness level is determined as belonging, so that the boundary value has a defined upper limit value and a defined lower limit value.

In another example, on the basis that the number of times the cleanliness level boundary value adjustment event cumulatively occurs is determined as being a threshold number or more, the processor 510 may control the user interface 430 to output at least one of an alarm for replacing the dust collection device 80 or an alarm for repairing the air purifier 20.

The configuration in which the number of times the event of adjusting a boundary value of a cleanliness level cumulatively occurs is a threshold number or more may include a case where the cleanliness in the indoor space is not improved, or a gap is formed between the user-perceived cleanliness and the measured cleanliness, even though the flow rate of the blower fan 30 is adjusted and the cleanliness level boundary value is adjusted in response to the continuous feedback request. Therefore, the processor 510 determines that another component included in the dust collection device 80 (specifically, the dust collection filter) or the air purifier 20 fails or decreases in performance

The processor 510 may control the user interface 430 to output at least one of the alarm for replacing the dust collection device 80 or the alarm for repairing the air purifier 20.

According to various embodiments, the processor 510 may control the output interface 432 to display at least one of the alarm for replacing the dust collection device 80 or the alarm for repairing the air purifier 20 on the user device.

Therefore, the air purifier 20 according to the embodiment may improve the performance of the air purifier 20 and the user satisfaction by means of the continuous request for user feedback for the performance of the air purifier 20 in the state in which the gap between the user-perceived cleanliness and the measured cleanliness is narrowed.

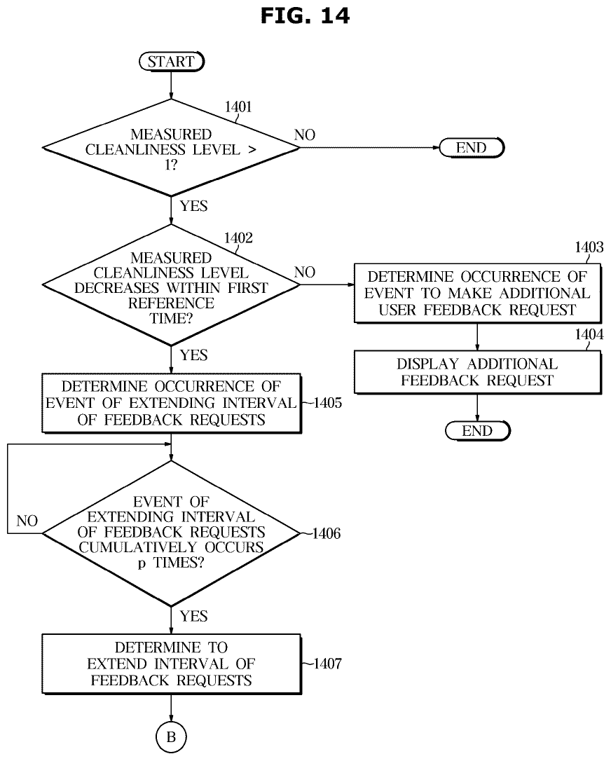

FIG. 14 is a view illustrating an example of a control flowchart of the air purifier 20 for adjusting a interval of request for user feedbacks or the number of request for user feedbacks.

According to an embodiment, the processor 510 may adjust the interval of request for user feedbacks or the number of request for user feedbacks depending on the operating performance of the air purifier 20 determined on the basis of the measured cleanliness.

The processor 510 according to the embodiment may determine whether the measured cleanliness corresponds to a lowermost level (1401). The processor 510 may obtain the information about the measured cleanliness from the server device 3 through the communication interface 440 and determine whether the measured cleanliness corresponds to the lowermost level. In this case, the lowermost level may include a cleanliness level corresponding to a level determined as being cleanest in air quality in the cleanliness level classification table. For example, with reference to FIG. 6, the processor 510 may determine whether the cleanliness level corresponds to Level 1.

In case that the measured cleanliness does not correspond to the lowermost level (YES in 1401), the processor 510 may determine whether the cleanliness level decreases within a first reference time (1402). In this case, the first reference time may be a defined time, i.e., a time shorter than the defined interval of request for user feedbacks. For example, in case that the defined interval of request for user feedbacks is six times a day, twice each in the morning, afternoon, and evening at two-hour intervals (eight o'clock, ten o'clock, twelve o'clock, fourteen o'clock, sixteen o'clock, and eighteen o'clock), the first reference time may be one hour.

In case that the cleanliness level does not decrease (NO in 1402) within the first reference time, the processor 510 may determine that event of making an additional request for user feedback occurs (1403). The occurrence of event of making an additional request for user feedback may be one of the condition for adjusting the interval of request for user feedbacks or the condition for adjusting the number of request for user feedbacks.

Therefore, the processor 510 may control the user interface 430 or the communication interface 440 to display an additional feedback request on the user interface 430 or the user device 2 on the basis that event of making an additional request for user feedback occurs (1404). In this case, on the basis that event of making an additional request for user feedback occurs, the processor 510 may determine whether the request for user feedback is scheduled in accordance with the defined interval of request for user feedbacks within a second reference time from a time point at which event of making an additional request for user feedback occurs. Therefore, in case that the request for user feedback is scheduled in accordance with the defined interval of request for user feedbacks, the processor 510 may withdraw the request for user feedback in accordance with the defined interval of request for user feedbacks.

In contrast, the processor 510 may determine that an event of extending an interval of the request for user feedbacks occurs (1405) in case that the measured cleanliness corresponds to the lowermost level (NO in 1401) or in case that the cleanliness level decreases within the first reference time even though the measured cleanliness does not correspond to the lowermost level (YES in 1402). The occurrence of the event of extending an interval of the request for user feedbacks may be one of the condition for adjusting the interval of request for user feedbacks or the condition for adjusting the number of request for user feedbacks.

The processor 510 may determine whether the event of extending an interval of the request for user feedbacks cumulatively occurs a defined number of times p (i.e., a second defined number of times) (1406).

The processor 510 may determine whether to extend the interval of request for user feedbacks (1407) on the basis that the event of extending an interval of the request for user feedbacks cumulatively occurs a defined number of times (i.e., a second defined number of times) (YES in 1406). Therefore, the processor 510 may extend the interval of request for user feedbacks on the basis that the extension of the interval of request for user feedbacks is determined. For example, in case that the defined feedback request cycle is six times a day, twice each in the morning, afternoon, and evening at two-hour intervals (eight o'clock, ten o'clock, twelve o'clock, fourteen o'clock, sixteen o'clock, and eighteen o'clock), the user feedback cycle may be extended to three times a day, once each in the morning, afternoon, and evening at four-hour intervals (eight o'clock, twelve o'clock, and sixteen o'clock) on the basis that the extension of the interval of request for user feedbacks is determined.

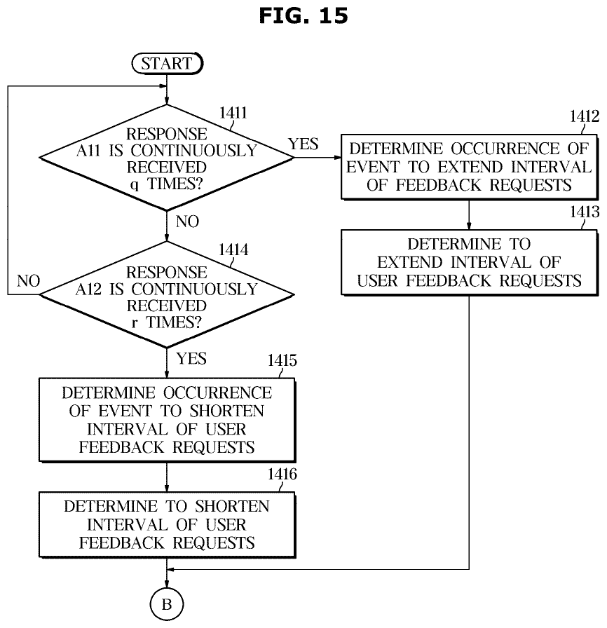

FIG. 15 is a view illustrating another example of a control flowchart of the air purifier 20 for adjusting the interval of request for user feedbacks or the number of request for user feedbacks.

According to an embodiment, the processor 510 may adjust the interval of request for user feedbacks or the number of request for user feedbacks on the basis of the user response.

With reference to FIG. 15, the processor 510 may determine whether a response (hereinafter, referred to as ‘A11’), which indicates satisfaction, to a question for identifying whether the user is satisfied with air quality according to measured satisfaction with respect to at least one question included in the request for user feedback is continuously obtained a defined number of times q (i.e., a third defined number of times) (1411).

In case that the processor 510 determines that response A11 is continuously obtained a defined number of times (i.e., a third defined number of times) (YES in 1411), the processor 510 may determine that the event of extending an interval of the request for user feedbacks occurs (1412). The occurrence of the event of extending an interval of the request for user feedbacks may be one of the condition for adjusting the interval of request for user feedbacks or the condition for adjusting the number of request for user feedbacks.

The processor 510 may determine to extend the interval of request for user feedbacks on the basis that the event of extending an interval of the request for user feedbacks occurs (1413). Therefore, the processor 510 may extend the interval of request for user feedbacks on the basis that the extension of the interval of request for user feedbacks is determined. For example, in case that the defined interval of request for user feedbacks is six times a day, twice each in the morning, afternoon, and evening at two-hour intervals (eight o'clock, ten o'clock, twelve o'clock, fourteen o'clock, sixteen o'clock, and eighteen o'clock), the interval of request for user feedbacks may be extended to three times a day, once each in the morning, afternoon, and evening at four-hour intervals (eight o'clock, twelve o'clock, and sixteen o'clock) on the basis that the extension of the interval of request for user feedbacks is determined.

In case that the processor 510 determines that response A11 is not continuously obtained a defined number of times (i.e., a third defined number of times) (YES in 1411), the processor 510 may determine whether the response (hereinafter, referred to as ‘A12’), which indicates dissatisfaction, to the question for identifying whether the user is satisfied with air quality according to measured cleanliness with respect to at least one question included in the request for user feedback is continuously obtained a defined number of times r (i.e., a fourth defined number of times) (1414).

In case that the processor 510 determines that response A12 is not continuously obtained a defined number of times (i.e., a fourth defined number of times) (NO in 1414), the processor 510 may determine whether the response (hereinafter, referred to as ‘A11’), which indicates satisfaction, to the question for identifying whether the user is satisfied with air quality according to measured satisfaction with respect to at least one question included in the request for user feedback is continuously obtained a defined number of times q (i.e., a third defined number of times) while consistently obtaining the response to the feedback request (1411).

In case that the processor 510 determines that response A12 is continuously obtained a defined number of times (i.e., a fourth defined number of times) (YES in 1414), the processor 510 may determine that the event of shortening an interval of the request for user feedbacks occurs (1415).

The processor 510 may determine to shorten the interval of request for user feedbacks on the basis that the event of shortening an interval of the request for user feedbacks occurs (1416). Therefore, the processor 510 may shorten the interval of request for user feedbacks on the basis that the shortening of the interval of request for user feedbacks is determined. For example, in case that the defined interval of request for user feedbacks is six times a day, twice each in the morning, afternoon, and evening at two-hour intervals (eight o'clock, ten o'clock, twelve o'clock, fourteen o'clock, sixteen o'clock, and eighteen o'clock), the interval of request for user feedbacks may be shortened to nine times a day, three times each in the morning, afternoon, and evening at one-and-half-hour intervals (eight o'clock, nine-thirty, eleven o'clock, twelve-thirty, fourteen o'clock, fifteen-thirty, seventeen, eighteen-thirty, and twenty o'clock) on the basis that the shortening of the interval of request for user feedbacks is determined.

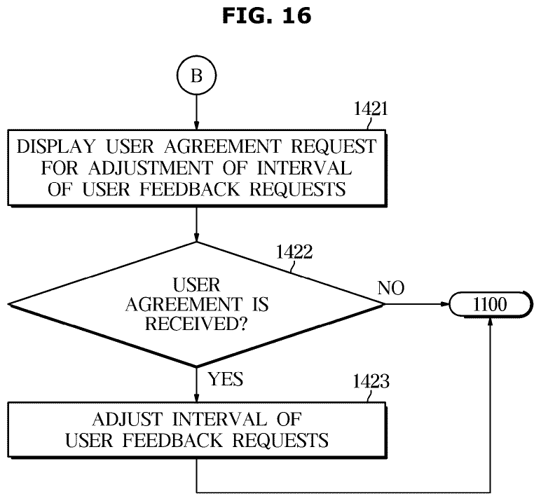

FIG. 16 is a view illustrating still another example of a control flowchart of the air purifier 20 for adjusting the interval of request for user feedbacks or the number of request for user feedbacks.

According to an embodiment, the processor 510 may adjust the interval of request for user feedbacks on the basis that the adjustment of the interval of request for user feedbacks is determined, and the processor 510 may adjust the interval of request for user feedbacks on the basis that the adjustment of the interval of request for user feedbacks is determined and the user agreement for the adjustment of the interval of request for user feedbacks is obtained. That is, the configuration in which the condition for adjusting the interval of request for user feedbacks or the condition for adjusting the number of request for user feedbacks are satisfied may include a configuration in which the occurrence of an event of adjusting the interval of the request for user feedbacks and the reception of the user agreement for the adjustment of the interval of request for user feedbacks are simultaneously satisfied. In this case, the adjustment of the interval of request for user feedbacks may include the extension of the interval of request for user feedbacks or the shortening of the interval of request for user feedbacks.

With reference to FIG. 16, the processor 510 may control at least one of the user interface 430 or the communication interface 440 to display the user agreement request for the adjustment of the interval of request for user feedbacks on the user interface 430 or the user device 2 on the basis that the event of adjusting the interval of the request for user feedbacks occurs (1421). The operation of displaying the user agreement request on the user interface 430 or the user device 2 may include an operation of displaying the question for identifying whether the user agreement for the adjustment of the interval of request for user feedbacks is made. In this case, the question for identifying whether the user agreement for the adjustment of the interval of request for user feedbacks is made may be displayed in the form of sensory information including visual or auditory information.

The processor 510 may determine whether the response indicating the agreement for the adjustment of the interval of request for user feedbacks to the user agreement request is obtained (1422). The processor 510 may obtain the response for the agreement for the adjustment of the interval of request for user feedbacks directly through the input interface 431 or indirectly through the communication interface 440.

The processor 510 may adjust the interval of request for user feedbacks (1423) on the basis that the response indicating the agreement for the adjustment of the interval of request for user feedbacks is obtained (YES in 1422). Therefore, the processor 510 may control at least one of the user interface 430 or the communication interface 440 to display the request for user feedback related to the measured cleanliness in the indoor space on the user interface 430 or the user device 2 in accordance with the adjusted interval of request for user feedbacks (1100).

In contrast, on the basis that the response indicating the agreement for the adjustment of the interval of request for user feedbacks is not obtained (NO in 1422), the processor 510 may control at least one of the user interface 430 or the communication interface 440 to display the request for user feedback related to the measured cleanliness in the indoor space on the user interface 430 or the user device 2 in accordance with the defined interval of request for user feedbacks (1100).

That is, the processor 510 may request the user feedback in accordance with the defined interval without adjusting the interval of request for user feedbacks in case that there is no user agreement even though the event of adjusting the interval of the request for user feedbacks occurs.

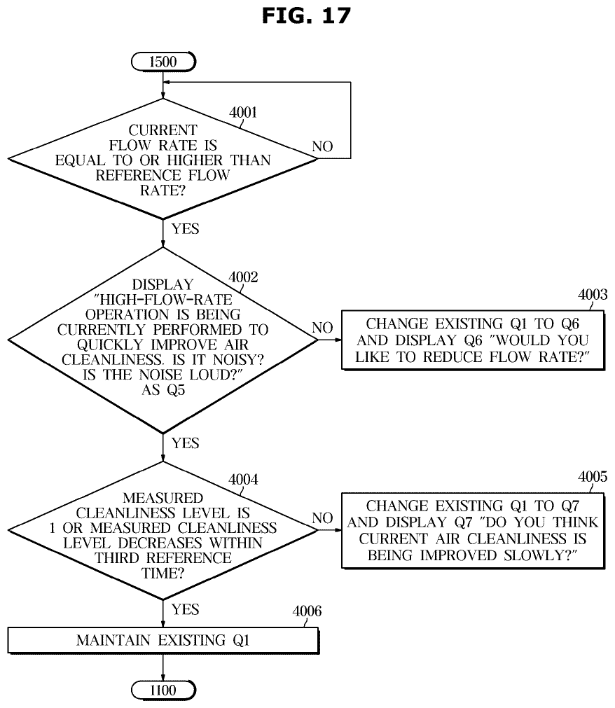

FIG. 17 is a view illustrating yet another example of a control flowchart of the air purifier 20 for changing a question included in the request for user feedback.

According to an embodiment, the processor 510 may adjust the interval of request for user feedbacks or the number of request for user feedbacks (1500) and determine whether the flow rate of the blower fan 30 is equal to or higher than a defined reference flow rate before requesting (1100) the user feedback in accordance with the adjusted interval or the adjusted number of times (4001).

Therefore, in case that the processor 510 determines that the flow rate of the blower fan 30 is equal to or higher than the defined reference flow rate (YES in 4001), the processor 510 may control at least one of the user interface 430 or the communication interface 440 to display the question for identifying whether the current flow rate is satisfied as a fifth question on the user interface 430 or the user device 2 (4002). For example, the fifth question “High-flow-rate operation is currently being performed to quickly improve air cleanliness. “Is it noisy?/Is the noise loud?” may be displayed on at least one of the user interface 430 or the user device 2 (4002).

The processor 510 may determine whether one of fifth responses defined to correspond to the fourth question is obtained, and the processor 510 may control at least one the user interface 430 or the communication interface 440 to display another question for adjusting the flow rate of the blower fan 30 instead of the question (i.e., the first question) for identifying whether the user is satisfied with air quality according to measured cleanliness in accordance with the obtained fifth response.

Specifically, in case that the processor 510 receives a response (e.g., “YES” A51), which indicates user dissatisfaction, as the fourth response, the processor 510 may change the first question to the sixth question and display the sixth question (4003). For example, the sixth question may include “Would you like to reduce flow rate?” as a question for adjusting the flow rate of the blower fan 30.

In contrast, in case that the processor 510 receives a response (e.g., “NO” A52), which indicates user satisfaction, as the fourth response, the processor 510 may determine whether another question is displayed instead of the first question on the basis of the measured cleanliness. At least one of the user interface 430 or the communication interface 440 may be controlled to display another question for adjusting the flow rate of the blower fan 30.

Specifically, the processor 510 may determine whether the cleanliness level is 1 or the cleanliness level decreases within the defined third reference time (4004).

In case that the cleanliness level is not 1 and the cleanliness level does not decrease within the defined third reference time (NO in 4004), the processor 510 may change the first question to the seventh question and display the seventh question (4005). A seventh question is a question for adjusting the flow rate of the blower fan 30 and may include “Do you think current air cleanliness is being improved slowly?”.

In case that the cleanliness level is 1 or the cleanliness level decreases within the defined third reference time (YES in 4004), the processor 510 may display the first question without changing the first question (4006).

That is, when a next request for user feedback is made on the basis of at least one of the user response for the question (i.e., the fifth question) for whether the flow rate is satisfied or the measured cleanliness, the processor 510 may control at least one of the user interface 430 or the communication interface 440 to display the question (i.e., the sixth question or the seventh question) for adjusting the flow rate, instead of the question (i.e., the first question) for identifying whether the air quality according to the measured cleanliness is satisfied, on the user interface 430 or the user device 2.

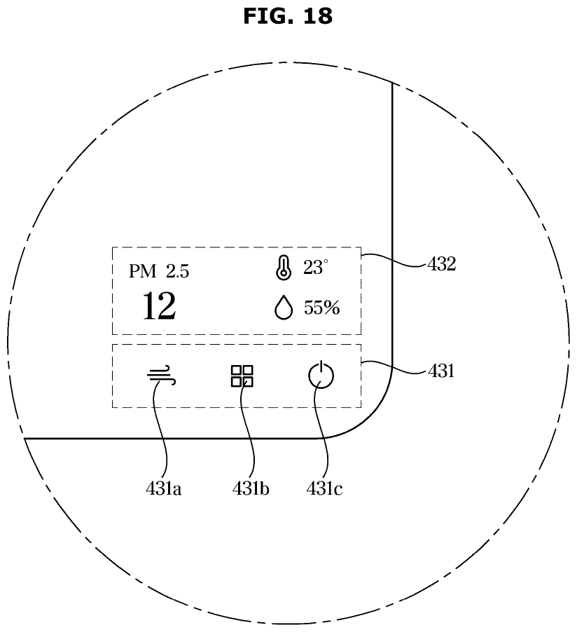

FIGS. 18 to 20 are views illustrating examples of the user interface 430 of the air purifier 20 according to an embodiment. FIGS. 18 to 20 are enlarged views of portion B in FIG. 2.

The user interface 430 of the air purifier 20 according to the embodiment may be implemented in various shapes.

For example, with reference to FIG. 18, the user interface 430 may include the output interface 432 configured to display information about the status and/or operation of the air purifier 20, and the input interface 431 including at least one user input button for obtaining an input related to the operation of the air purifier 20. In this case, the user input button may be implemented as a keypad, mouse, trackball, jog switch, knob, touch pad, or touch screen.

With reference to FIG. 18, the input interface 431 of the air purifier may further include a separate button 431d configured to obtain the user response related to the request for user feedback as well as a flow rate button 431a configured to adjust the flow rate of the air purifier 20, a menu button 431b configured to determine various operation modes of the air purifier 20, or a power button 431c configured to obtain the user input related to the power on/off of the air purifier 20.

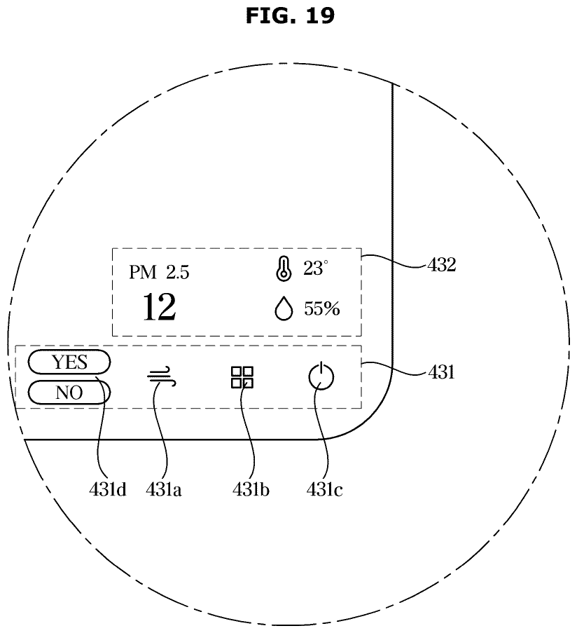

In contrast, as illustrated in FIG. 19, in case that the air purifier 20 according to the embodiment does not include a separate input button configured to obtain the response related to the request for user feedback, the air purifier 20 may obtain the user response related to the request for user feedback by using a button that performs another function. In this case, the processor 510 may control the output interface 432 to output an instruction for obtaining the user response by using the button that performs another function.

For example, in case that the processor 510 determines that the flow rate button 431a and the menu button 431b are simultaneously pressed for 3 seconds, the processor 510 may determine that the user response, which indicates that the question related to whether the air quality according to the measured cleanliness is satisfied is satisfied, is obtained. In addition, in case that the processor 510 determines that the flow rate button 431a and the menu button 431b are simultaneously pressed for 5 seconds, the processor 510 may determine that the user response, which indicates that the question (i.e., the first question) related to whether the air quality according to the measured cleanliness is satisfied is not satisfied, is obtained. In this case, the processor 510 may control the speaker included in the output interface 432 and output an instruction “Press the flow rate button 431a and the menu button 431b simultaneously for 3 seconds when you are satisfied with the air quality or press the flow rate button 431a and the menu button 431b simultaneously for 5 seconds when you are not satisfied with the air quality” to the question (i.e., the first question) related to whether the air quality according to the measured cleanliness is satisfied.

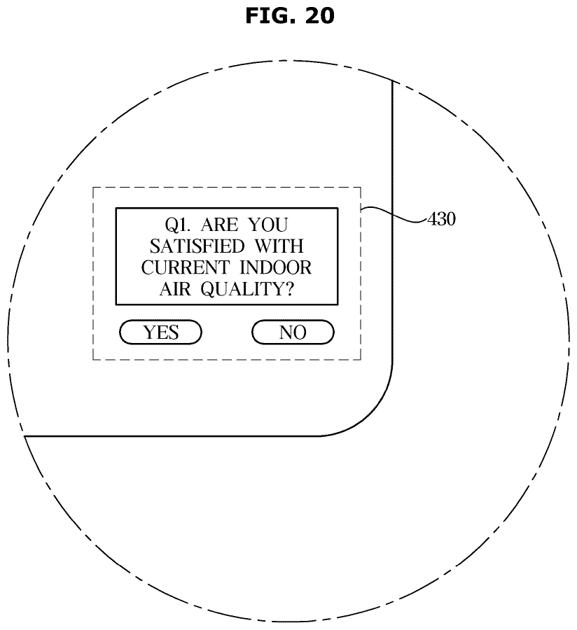

According to various embodiments, the user interface 430 may be implemented as a touch display panel. With reference to FIG. 20, in the user interface 430 implemented as a touch display panel, at least one question included in the request for user feedback may be displayed on the display panel, and the user response may be obtained by the user touching the GUI displayed on the display panel. In this case, the processor 510 may output the instruction as auditory information by controlling the speaker or output the instruction as visual information by means of the touch display panel.

However, FIGS. 18 to 20 merely illustrate some examples of the implementation form of the user interface 430, and it is obvious to those skilled in the art that various implementation forms may be adopted without being limited to these examples.

An embodiment provides an air purifier may including a dust collection device configured to collect dust from air; a fan configured to generate a flow of air from an indoor space through the dust collection device; a user interface; a communication interface configured to communicate with at least one of a server or a user device; and a processor configured to: identify cleanliness level of the air in the indoor space, control at least one of the user interface to display or the communication interface to transmit to the at least one of the server or the user device, based on a defined interval or a defined number of times, a request for user feedback on the cleanliness level, obtain the user feedback through at least one of the user interface or the communication interface, based on the obtained user feedback, identify a user-perceived cleanliness level of the air in the indoor space, based on the user-perceived cleanliness level, control an operation of the fan, and based on at least one of the obtained user feedback or the cleanliness level, adjust at least one of the defined interval or the defined number of times.

The processor may be further configured to: obtain information about the measured cleanliness from the server through the communication interface, based on the obtained information, identify whether the cleanliness level corresponds to a lowest level, and based on the identifying that the cleanliness level corresponds to the lowest level, determine that an event of extending the defined interval has occurred, wherein the lowest level corresponds to a level indicating the best air quality.

The processor may be further configured to: based on the identifying that the cleanliness level does not correspond to the lowest level, identify whether the cleanliness level changes within a first reference time, and based on the identifying that the identified cleanliness level decreases to at least a defined number of levels within the first reference time, determine that the event of extending the defined interval has occurred, wherein the decrease in the cleanliness level corresponds to an improvement in the air quality.

The processor may be further configured to, based on the determining that the event of extending the defined interval has cumulatively occurred a second defined number of times, extend the defined interval.

The processor may be further configured to: based on the determining that the event of extending the defined interval has cumulatively occurred a second defined number of times, control at least one of the user interface to display or the communication interface to transmit to the at least one of the server or the user device, a request for a user agreement on extending the defined interval, and based on the user agreement on extending the defined interval being obtained, extend the defined interval.

The processor may be further configured to, based on the identifying that the cleanliness level does not decrease to at least the defined number of levels within the first reference time, determine that an event to request for additional user feedback has occurred.

The processor may be further configured to: identify whether the request for user feedback based on the defined interval is scheduled within a second reference time, and based on the identifying that the request for user feedback based on the defined interval is scheduled within the second reference time, withdraw the request for user feedback based on the defined interval.

The request for user feedback includes a question whether an air quality of the air from the indoor space is satisfactory, and the processor may be further configured to, based on the user feedback indicating the air quality of the air from the indoor space is satisfactory being continuously obtained the third defined number of times, determine that an event of extending the defined interval has occurred.

The request for user feedback includes a question whether an air quality of the air from the indoor space is satisfactory, and the processor may be further configured to, based on the user feedback indicating the air quality of the air from the indoor space is unsatisfactory being continuously obtained a fourth defined number of times, determine that an event of shortening the defined interval has occurred.

The processor may be further configured to, based on a determination that the event of extending the defined interval has occurred, extend the defined interval.

The processor may be further configured to, based on a determining that the event of extending the defined interval has occurred, control at least one of the user interface to display or the communication interface to transmit to the at least one of the server or the user device, a question for identifying whether a user agrees to adjust the defined interval, and based on user feedback indicating a user agreement to extend the defined interval being obtained, extend the defined interval.

The request for user feedback includes a question identifying whether an air quality of the air from the indoor space based on cleanliness level is satisfactory, the indoor space includes at least one of an installation space in which the air purifier is installed or a space surrounding the installation space, and the processor may be further configured to, based on the user feedback indicating the air quality of the air from the indoor space is unsatisfactory being obtained, control at least one of the user interface to display or the communication interface to transmit to the at least one of the server or the user device, a question for identifying whether a user is in the installation space.

The processor may be further configured to: based on obtaining the user feedback through at least one of the user interface or the communication interface indicating that the user is in the installation space, identify a difference between the user-perceived cleanliness and the cleanliness level, and based on the identified difference being greater than or equal to a defined difference, determine that an event of adjusting a boundary value of a cleanliness level has occurred.

The processor may be further configured to, based on the determining that the event of adjusting the boundary value of the cleanliness level has cumulatively occurred a fifth defined number of times, adjust a boundary value of a set cleanliness level corresponding to the cleanliness level or control the user interface to output a notification on performance or state of the air purifier.

The processor may be further configured to, based on a determining that the event of adjusting the boundary value of the cleanliness level has cumulatively occurred the fifth defined number of times, decrease an upper limit value and a lower limit value of the boundary value of the set cleanliness level corresponding to the cleanliness level by a defined amount.

The processor may be further configured to, based on a determination that the event of shortening the defined interval has occurred, shorten the defined interval.

The processor may be further configured to, based on a determination that the event of shortening the defined interval as occurred, control at least one of the user interface or the communication interface to display a request for identifying whether a user agreement for an adjustment of the defined interval was made on the user interface or the user device, and based on the identifying the user agreement for the adjustment of the defined interval was made, shorten the defined interval.

The processor may be further configured to, based on a determining that a cumulative number of occurrences of the event of adjusting the boundary value of the cleanliness level is equal to or greater than a threshold number, control at least one of the user interface to display or the communication interface to transmit to the at least one of the server or the user device notification on at least one of a replacement or repair of the dust collection device.

The processor may be further configured to, based on the user-perceived cleanliness, control at least one of a flow rate or a flow direction of the fan.

An embodiment provides a method of controlling an air purifier including identifying cleanliness level of the air in the indoor space, displaying or transmitting, based on a defined interval or a defined number of times, a request for user feedback on the cleanliness level, obtaining the user feedback, based on the obtained user feedback, identifying a user-perceived cleanliness level of the air in the indoor space, based on the user-perceived cleanliness, controlling an operation of the fan, and based on at least one of the obtained user feedback or the cleanliness level, adjusting at least one of the defined interval or the defined number of times.

However, the effects obtained by the air purifier and the method of controlling the same of the present disclosure are not limited to the aforementioned effects, and other effects, which are not mentioned above, will be clearly understood by those skilled in the art from the following description. On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read-only memory (ROM), a random-access memory (RAM), a magnetic tape, a magnetic disc, a flash memory, an optical data storage device, and the like.

In addition, the computer-readable recording medium may be provided in the form of a non-transitory storage medium. Here, the term “non-transitory storage medium” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

According to the embodiment, a method according to various embodiments disclosed in the present document may be included and provided in a computer program product. The computer program product may be traded as a product between a seller and a buyer. The computer program product may be distributed in the form of a machine-readable recording medium (e.g., compact disc read only memory (CD-ROM)), or be distributed (e.g., downloaded or uploaded) on-line via an application store (e.g., PLAYSTORE™), or between two user devices (e.g., smart phones) directly. If distributed on-line, at least portion of the computer program product (e.g., a downloadable app) may be temporarily generated or at least temporarily stored in the machine-readable recording medium, such as memory of the manufacturer's server, a server of the application store, or a relay server.

The particular embodiment has been illustrated and described above. However, the present disclosure is not limited to the foregoing embodiments, and those skilled in the art will recognize that various modifications can be made without departing from the technical spirit of the present disclosure as set forth in the following claims.

1. An air purifier comprising:
a dust collection device configured to collect dust from air;
a fan configured to generate a flow of air from an indoor space through the dust collection device;
a user interface;
a communication interface configured to communicate with at least one of a server or a user device; and
a processor configured to:
identify cleanliness level of the air in the indoor space,
control at least one of the user interface to display or the communication interface to transmit to the at least one of the server or the user device, based on a defined interval or a defined number of times, a request for user feedback on the cleanliness level,
obtain the user feedback through at least one of the user interface or the communication interface,
based on the obtained user feedback, identify a user-perceived cleanliness level of the air in the indoor space,
based on the user-perceived cleanliness level, control an operation of the fan, and
based on at least one of the obtained user feedback or the cleanliness level, adjust at least one of the defined interval or the defined number of times.

2. The air purifier of claim 1, wherein
the processor is further configured to:
obtain information about the measured cleanliness from the server through the communication interface,
based on the obtained information, identify whether the cleanliness level corresponds to a lowest level, and
based on the identifying that the cleanliness level corresponds to the lowest level, determine that an event of extending the defined interval has occurred,
wherein the lowest level corresponds to a level indicating the best air quality.

3. The air purifier of claim 2, wherein
the processor is further configured to:
based on the identifying that the cleanliness level does not correspond to the lowest level, identify whether the cleanliness level changes within a first reference time, and
based on the identifying that the identified cleanliness level decreases to at least a defined number of levels within the first reference time, determine that the event of extending the defined interval has occurred,
wherein the decrease in the cleanliness level corresponds to an improvement in the air quality.

4. The air purifier of claim 3, wherein
the processor is further configured to:
based on the determining that the event of extending the defined interval has cumulatively occurred a second defined number of times, extend the defined interval.

5. The air purifier of claim 3, wherein
the processor is further configured to:
based on the determining that the event of extending the defined interval has cumulatively occurred a second defined number of times, control at least one of the user interface to display or the communication interface to transmit to the at least one of the server or the user device, a request for a user agreement on extending the defined interval, and
based on the user agreement on extending the defined interval being obtained, extend the defined interval.

6. The air purifier of claim 3, wherein
the processor is further configured to:
based on the identifying that the cleanliness level does not decrease to at least the defined number of levels within the first reference time, determine that an event to request for additional user feedback has occurred.

7. The air purifier of claim 6, wherein
the processor is further configured to:
identify whether the request for user feedback based on the defined interval is scheduled within a second reference time, and
based on the identifying that the request for user feedback based on the defined interval is scheduled within the second reference time, withdraw the request for user feedback based on the defined interval.

8. The air purifier of claim 1, wherein
the request for user feedback includes a question whether an air quality of the air from the indoor space is satisfactory, and
the processor is further configured to:
based on the user feedback indicating the air quality of the air from the indoor space is satisfactory being continuously obtained the third defined number of times, determine that an event of extending the defined interval has occurred.

9. The air purifier of claim 1, wherein
the request for user feedback includes a question whether an air quality of the air from the indoor space is satisfactory, and
the processor is further configured to:
based on the user feedback indicating the air quality of the air from the indoor space is unsatisfactory being continuously obtained a fourth defined number of times, determine that an event of shortening the defined interval has occurred.

10. The air purifier of claim 8, wherein
the processor is further configured to:
based on a determination that the event of extending the defined interval has occurred, extend the defined interval.

11. The air purifier of claim 8, wherein
the processor is further configured to:
based on a determining that the event of extending the defined interval has occurred, control at least one of the user interface to display or the communication interface to transmit to the at least one of the server or the user device, a question for identifying whether a user agrees to adjust the defined interval, and
based on user feedback indicating a user agreement to extend the defined interval being obtained, extend the defined interval.

12. The air purifier of claim 1, wherein
the request for user feedback includes a question identifying whether an air quality of the air from the indoor space based on cleanliness level is satisfactory,
the indoor space includes at least one of an installation space in which the air purifier is installed or a space surrounding the installation space, and
the processor is further configured to:
based on the user feedback indicating the air quality of the air from the indoor space is unsatisfactory being obtained, control at least one of the user interface to display or the communication interface to transmit to the at least one of the server or the user device, a question for identifying whether a user is in the installation space.

13. The air purifier of claim 12, wherein
the processor is further configured to:
based on obtaining the user feedback through at least one of the user interface or the communication interface indicating that the user is in the installation space, identify a difference between the user-perceived cleanliness and the cleanliness level, and
based on the identified difference being greater than or equal to a defined difference, determine that an event of adjusting a boundary value of a cleanliness level has occurred.

14. The air purifier of claim 13, wherein
the processor is further configured to:
based on the determining that the event of adjusting the boundary value of the cleanliness level has cumulatively occurred a fifth defined number of times, adjust a boundary value of a set cleanliness level corresponding to the cleanliness level or control the user interface to output a notification on performance or state of the air purifier.

15. The air purifier of claim 14, wherein
the processor is further configured to:
based on a determining that the event of adjusting the boundary value of the cleanliness level has cumulatively occurred the fifth defined number of times, decrease an upper limit value and a lower limit value of the boundary value of the set cleanliness level corresponding to the cleanliness level by a defined amount.

16. The air purifier of claim 9, wherein
the processor is further configured to:
based on a determination that the event of shortening the defined interval has occurred, shorten the defined interval.

17. The air purifier of claim 9, wherein
the processor is further configured to:
based on a determination that the event of shortening the defined interval as occurred, control at least one of the user interface or the communication interface to display a request for identifying whether a user agreement for an adjustment of the defined interval was made on the user interface or the user device, and
based on the identifying the user agreement for the adjustment of the defined interval was made, shorten the defined interval.

18. The air purifier of claim 14, wherein
the processor is further configured to:
based on a determining that a cumulative number of occurrences of the event of adjusting the boundary value of the cleanliness level is equal to or greater than a threshold number, control at least one of the user interface to display or the communication interface to transmit to the at least one of the server or the user device notification on at least one of a replacement or repair of the dust collection device.

19. The air purifier of claim 1, wherein
the processor is further configured to:
based on the user-perceived cleanliness, control at least one of a flow rate or a flow direction of the fan.

20. The method of controlling an air purifier comprising:
identifying cleanliness level of the air in the indoor space,
displaying or transmitting, based on a defined interval or a defined number of times, a request for user feedback on the cleanliness level,
obtaining the user feedback,
based on the obtained user feedback, identifying a user-perceived cleanliness level of the air in the indoor space,
based on the user-perceived cleanliness, controlling an operation of the fan, and
based on at least one of the obtained user feedback or the cleanliness level, adjusting at least one of the defined interval or the defined number of times.
